(19) United States
(12) Patent Application Publication
(10) Pub. No.: US 2024/0111487 A1
(43) Pub. Date: Apr. 4, 2024

(54) INFORMATION PROCESSING APPARATUS

(71) Applicant: Sony Group Corporation, Tokyo (JP)

(72) Inventors: Hiro IWASE, Tokyo (JP); Yuhei TAKI, Tokyo (JP); Kunihito SAWAI, Tokyo (JP)

(73) Assignee: Sony Group Corporation, Tokyo (JP)

(21) Appl. No.: 17/768,220

(22) PCT Filed: Oct. 30, 2020
(86) PCT No.: PCT/JP2020/040799

§ 371 Date: Apr. 12, 2022

(30) Foreign Application Priority Data
Nov. 13, 2019 (JP) 2019-205541

(51) Int. Cl. G06F 3/16; G06F 3/0484

(52) U.S. Cl. CPC G06F 3/167; G06F 3/0484

(57) ABSTRACT

The present disclosure relates to an information processing apparatus capable of easily changing a cluster for collectively operating a plurality of operations to which a user is habituated.

A dialog cluster including a plurality of operations having a habituation score indicating habituation of an operation of a user higher than a predetermined threshold and an operation according to a dialog with the user is registered. The technology of the present disclosure can be applied to an information processing apparatus.

### TECHNICAL FIELD

The present disclosure relates to an information processing apparatus, and more particularly, to an information processing apparatus capable of easily changing a cluster for collectively operating a plurality of operations to which a user is habituated.

### BACKGROUND ART

A technology of estimating an operation habit of a user from an operation history of the user and assisting the operation of the user has been proposed.

For example, a technology has been proposed in which an operation history is stored, a next operation is predicted from a transition probability, and the predicted next operation is performed (see Patent Document 1).

Furthermore, a technology of estimating a viewing habit with respect to a day or time from a viewing history and assisting an operation related to viewing has been proposed (see Patent Document 2).

However, in the technology of Patent Document 1, it is not possible to estimate a plurality of operations (cluster/last determination as a group of operations) having simultaneity in consideration of a time interval of operations, and moreover, it is not possible to detect an operation in which the order of the plurality of operations may change.

Furthermore, the technology of Patent Document 2 cannot estimate habituation based on continuity or simultaneity of a plurality of operations.

Therefore, it is conceivable to generate a cluster that can be easily and collectively operated by clustering a plurality of operations to which the user is habituated as a group of operations.

Even if a cluster in which a plurality of operations is clustered as a group of operations is generated in this manner, it may be necessary to use each operation with a change in accordance with a change in behavior of the user.

However, in order to change an individual operation, it is necessary to individually designate an operation to be changed, which is a heavy burden on the user.

Therefore, there has been proposed a technology of changing a cluster for collectively operating a plurality of operations by generating a scenario-based dialog, providing blank items in part, and completing the dialog by filling the blank items from a past behavior history

(Patent Document 3).

### CITATION LIST

### Patent Document

Patent Document 1: Japanese Patent No. 5340774
Patent Document 2: Japanese Patent No. 5175518
Patent Document 3: Japanese Patent Application Laid-Open No. 2019-105685

### SUMMARY OF THE INVENTION

### Problems to be Solved by the Invention

However, in a case where a blank item is provided in the scenario-based speech dialog and the blank item is filled from the behavior history using the technology of Patent Document 3, it is not possible to change individual operations of a cluster including a group of a plurality of operations on the basis of the habituation of combined operations.

Therefore, the cluster cannot be appropriately changed in response to the change in the habit of the combined operations.

The present disclosure has been made in view of such a situation, and particularly, an object of the present disclosure is to easily change a cluster, which is a group of a plurality of operations to which a user is habituated, by an appropriate dialog based on estimation of habituation of the user.

### Solutions to Problems

An information processing apparatus according to one aspect of the present disclosure is an information processing apparatus including a control unit that calculates a habituation score indicating habituation of a user operation, and registers a cluster including a plurality of operations including an operation in which the habituation score is higher than a predetermined threshold and an operation according to a dialog with a user.

In the one aspect of the present disclosure, a habituation score indicating habituation of a user operation is calculated, and a cluster including a plurality of operations including an operation in which the habituation score is higher than a predetermined threshold and an operation according to a dialog with a user is registered.

### BRIEF DESCRIPTION OF DRAWINGS

FIG. 1 is a diagram for explaining browsing so far.

FIG. 2 is a diagram for explaining macro registration processing so far.

FIG. 3 is a diagram illustrating an outline of the present disclosure.

FIG. 4 is a diagram for explaining a configuration example of an information processing apparatus of the present disclosure.

FIG. 5 is a diagram for explaining a habituation score corresponding to user operation information.

FIG. 6 is a flowchart for explaining habituation operation clustering processing.

FIG. 7 is a diagram for explaining integration of habituation operation clusters.

FIG. 8 is a diagram for explaining integration of habituation operation clusters.

FIG. 9 is a flowchart for explaining dialog clustering processing.

FIG. 10 is a diagram for explaining an operation having the same operation type (Intent) and a different attribute (Entity).

FIG. 11 is a diagram for explaining determination processing for an operation having the same operation type (Intent) and a different attribute (Entity).

FIG. 12 is a diagram for explaining a case of dialog generation for an operation having the same Intent and a different Entity.

FIG. 13 is a flowchart for explaining dialog processing for an operation having the same Intent and a different Entity.

FIG. 14 is a diagram for explaining an added operation.

FIG. 15 is a diagram for explaining a deleted operation.

FIG. 16 is a flowchart for explaining added and deleted operation determination processing.

FIG. 17 is a diagram for explaining a dialog generation case for added and deleted operations.

FIG. 18 is a diagram for explaining dialog processing for added and deleted operations.

FIG. 19 is a diagram for explaining an operation depending on an observation context.

FIG. 20 is a flowchart for explaining determination processing of an operation depending on an observation context.

FIG. 21 is a flowchart for explaining context information update processing of a dialog cluster candidate.

FIG. 22 is a diagram for explaining a dialog generation case for an observation context-dependent operation.

FIG. 23 is a flowchart for explaining dialog processing for an observation context-dependent operation.

FIG. 24 is a diagram for explaining a configuration example of a general-purpose personal computer.

### MODE FOR CARRYING OUT THE INVENTION

Preferred embodiments of the present disclosure will be described in detail below with reference to the accompanying drawings. Note that, in the present specification and the drawings, the same reference numerals are given to the constituent elements having substantially the same functional configuration, and redundant explanations are omitted.

Hereinafter, embodiments for carrying out the present technology will be described. The description will be given in the following order.
1. Outline of the present disclosure
2. Preferred embodiments
3. Example of executing by software

### 1. Outline of the Present Disclosure

<Browsing>

An object of the present disclosure is to easily change a cluster, which is a group of a plurality of operations to which a user is habituated, by an appropriate dialog based on estimation of habituation of the user.

First, an outline of the present disclosure will be described.

An outline of the present disclosure will be described by exemplifying a case where a user browses using a web browser of a personal computer (PC), for example.

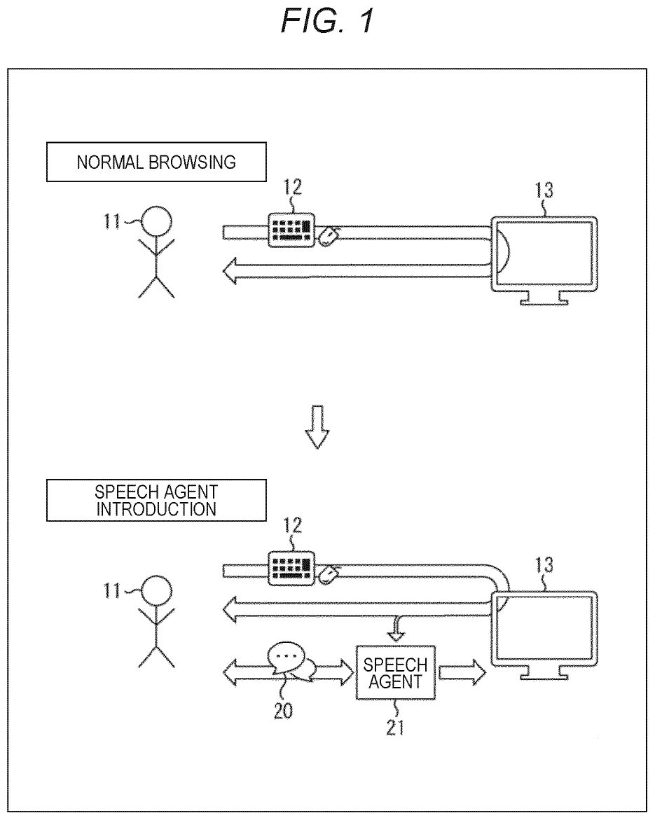

At the time of normal browsing, as illustrated in the upper part of FIG. 1, a user 11 operates an operation input device 12 including a keyboard, a mouse, or the like of a PC 13, inputs a keyword, various operation instructions, or the like to cause searching for an article in a browser so that a search result is presented, and thereby, browsing is achieved.

However, as illustrated in the upper part of FIG. 1, in the operation in which the user 11 operates the operation input device 12 to input a keyword or various operation instructions, it is necessary to input a plurality of pieces of information in a predetermined order, and the operation becomes complicated as the amount of information to be input increases.

Furthermore, in a case of a habituated operation, a plurality of similar operations needs to be repeated.

Therefore, as illustrated in the lower part of FIG. 1, a technology has been proposed in which a speech input device 20 or the like by a microphone or the like is attached in addition to the operation input device 12 to receive input by speech so that input can be performed in a dialog manner by a speech agent 21.

In this case, the user 11 can input information in a dialog manner to the speech agent 21 via the speech input device 20 by operating the operation input device 12 or by utterance.

As a result, as illustrated in the lower part of FIG. 1, in a case where the speech agent 21 is used, in the input operation using the operation input device 12, a plurality of necessary operations can be subjected to macro processing and can be collectively performed only by uttering the associated phrase.

That is, a plurality of operations is subjected to macro processing and is stored in association with one phrase, and when the stored phrase is uttered, the plurality of macro operations is collectively performed.

In order to collectively perform a plurality of operations that has been subjected to macro processing by the speech utterance of the predetermined phrase as described above, first, macro registration processing of subjecting a plurality of operations to macro processing and registering the plurality of operations in association with a predetermined phrase is necessary.

<Macro Registration Processing in Browsing>

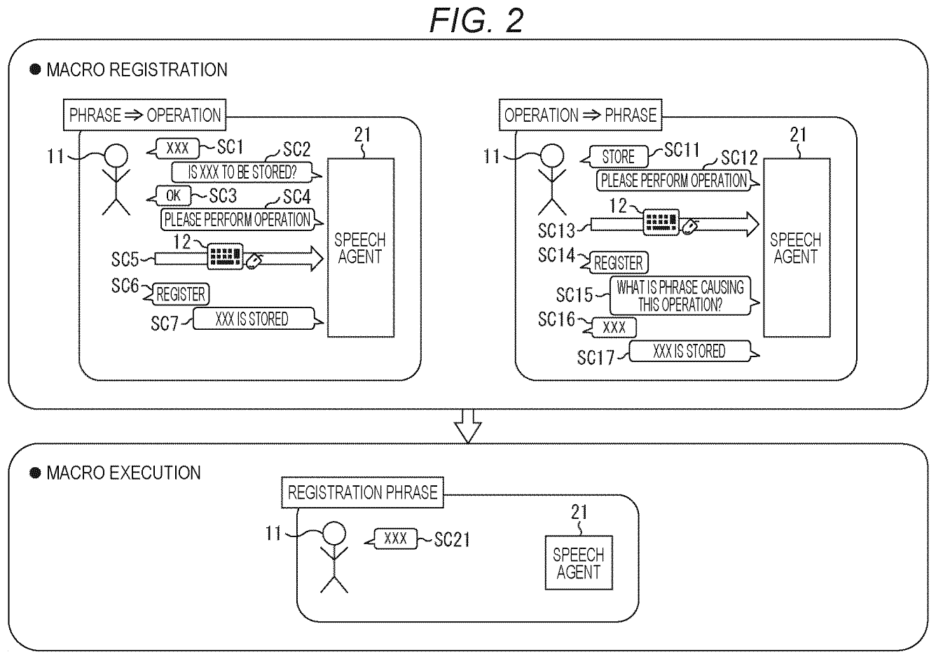

As illustrated in the upper part of FIG. 2, there are two methods for this macro registration processing.

That is, as illustrated in the upper left part of FIG. 2, a first method of the macro registration processing is to subject a plurality of operations to macro processing and store the operations in association with a phrase when there is an utterance of a phrase that is not macro-registered.

Furthermore, as illustrated in the upper right part of FIG. 2, a second method of the macro registration processing is to subject a plurality of operations to macro processing, and then store the plurality of macro operations in association with a phrase when there is an utterance of the phrase to be stored in association.

(First Method of Macro Registration Processing)

For example, in the first method of the macro registration processing, as illustrated in the upper left part of FIG. 2, in processing SC1, when the speech agent 21 detects a phrase “XXX” uttered by the user 11 via the speech input device 20, whether or not the phrase is a macro-registered phrase is determined.

Here, in a case where the phrase is not a macro-registered phrase, in processing SC2, the speech agent 21 presents information such as “Is XXX to be stored?” by an image or speech from a display, a speaker, or the like (not illustrated), of the PC 13, and inquires whether or not a plurality of operations should be subjected to macro processing and registered in association with the phrase “XXX”.

In response to the inquiry, in processing SC3, when it is detected that a phrase “OK” has been uttered by the user 11 via the speech input device 20, the speech agent 21 recognizes that there has been a request for macro processing and registration of a plurality of operations in association with the “XXX”.

Next, in processing SC4, the speech agent 21 utters “Please perform an operation”, for example, from a display, a speaker, or the like (not illustrated) of the PC 13 by an image or a speech, thereby notifying the user 11 that preparation for sequentially storing the subsequent operation contents of the operation input device 12 by the user 11 is ready.

In response to this, in processing SC5, the operation input device 12 is operated by the user 11 to input a plurality of operations for macro registration, and the speech agent 21 sequentially stores the plurality of input operations.

When the plurality of operation inputs is completed, in processing SC6, for example, the phrase “Register” is uttered by the user 11, and thereby, the speech agent 21 recognizes that the plurality of operation inputs for macro registration is completed.

Then, in processing SC7, the speech agent 21 registers the phrase “XXX” and a plurality of operations stored so far in association with each other as a macro, and utters “XXX is stored” with an image or a speech from a display, a speaker, or the like (not illustrated) of the PC 13, to notify the user 11 that the plurality of operation inputs input so far is converted into a macro, and registered in association with the phrase “XXX”.

Through this series of processing, a plurality of operation inputs is subjected to macro processing and registered in association with the phrase “XXX”.

As a result, hereinafter, for example, as illustrated in the lower part of FIG. 2, when the user 11 utters “XXX”, the speech agent 21 considers that an instruction for the execution of the macro registered in association with “XXX” has been given by the user, and collectively performs the plurality of operation inputs registered in association.

(Second Method of Macro Registration Processing)

For example, in the second method of the macro registration processing, as illustrated in the upper right part of FIG. 2, when the user 11 desires to subject a plurality of operations to macro processing and register the operations with respect to a predetermined phrase, the user utters “Store”.

In processing SC11, when the speech agent 21 detects the phrase “Store” uttered by the user 11 via the speech input device 20, the speech agent 21 recognizes that it is desired to subject a plurality of operations to macro processing and register the operations with respect to a predetermined phrase.

Then, in processing SC12, the speech agent 21 utters “Please perform an operation”, for example, from a display, a speaker, or the like (not illustrated) of the PC 13 by an image or a speech, thereby notifying the user 11 that preparation for sequentially storing the subsequent operation contents of the operation input device 12 by the user 11 is ready.

In response to this, when the operation input device 12 is operated by the user 11 to input a plurality of operations for macro registration, in processing SC13, the speech agent stores the plurality of operation inputs that has been input.

When completing a plurality of operation inputs to be macro-registered, the user 11 notifies the speech agent 21 of the completion of the plurality of operation inputs by uttering a phrase “Register”.

As a result, in processing SC14, the speech agent 21 detects the phrase “Register” uttered by the user 11 via the speech input device 20, thereby recognizing the completion of a plurality of operation inputs for macro registration.

Moreover, in processing SC15, the speech agent 21 utters, for example, “What is the phrase causing this operation?” with an image or speech from a display, a speaker, or the like (not illustrated) of the PC 13, to inquire about a phrase stored in association with a plurality of operations to be macro-registered input by the operation of the operation input device 12 by the user 11.

In response to this, the user 11 issues an instruction to subject the plurality of operations stored so far to macro processing and register the operations in association with the phrase “XXX”, for example.

In processing SC16, when the speech agent 21 detects the phrase “XXX” uttered by the user 11 via the speech input device 20, the speech agent 21 recognizes that there has been an instruction to subject a plurality of operations stored so far to macro processing and store the operations in association with the phrase “XXX”.

In processing SC17, the speech agent 21 subjects a plurality of operations stored so far to macro processing and register the operations in association with the phrase “XXX”. Then, the speech agent 21 utters “XXX is stored” for example, with an image or a speech from a display, a speaker, or the like (not illustrated) of the PC 13, to notify the user 11 that the plurality of operation inputs input so far is converted into a macro and registered in association with the phrase “XXX”.

Through this series of processing, a plurality of operation inputs is subjected to macro processing and registered in association with the phrase “XXX”.

Even after such registration, as illustrated in the lower part of FIG. 2, when the user 11 utters the phrase “XXX”, a plurality of macro operations registered in association is collectively performed.

However, the macro registration processing described above is basically based on the premise that the user stores a plurality of operations in both the first method and the second method, and it is only possible to register the plurality of stored operations in association with a phrase.

That is, unless the user himself/herself recognizes and grasps what he/she operates as a habit in normal operation in normal browsing, the macro registration cannot be performed.

Furthermore, even if the user recognizes and grasps his/her habitual operation and can perform macro registration, in a case where the user forgets the macro-registered phrase itself, the user may not be able to collectively perform a plurality of macro operations by uttering the macro-registered phrase.

Therefore, it is conceivable to collectively perform a plurality of operations while reducing the load of the user by estimating a plurality of habitual operations of the user as a cluster from the operation history and causing the user to recognize the plurality of operations.

<Clustering of User Operation History>

That is, it is conceivable to generate a habituation operation cluster by clustering a plurality of operations having a high degree of habituation on the basis of the user operation history, and collectively perform speech macro processing in units of the habituation operation cluster, suggestion of macro processing by a situation proposal notification, and a habituation operation cluster including a keyword having a matching degree higher than a predetermined matching degree with the utterance keyword of the user.

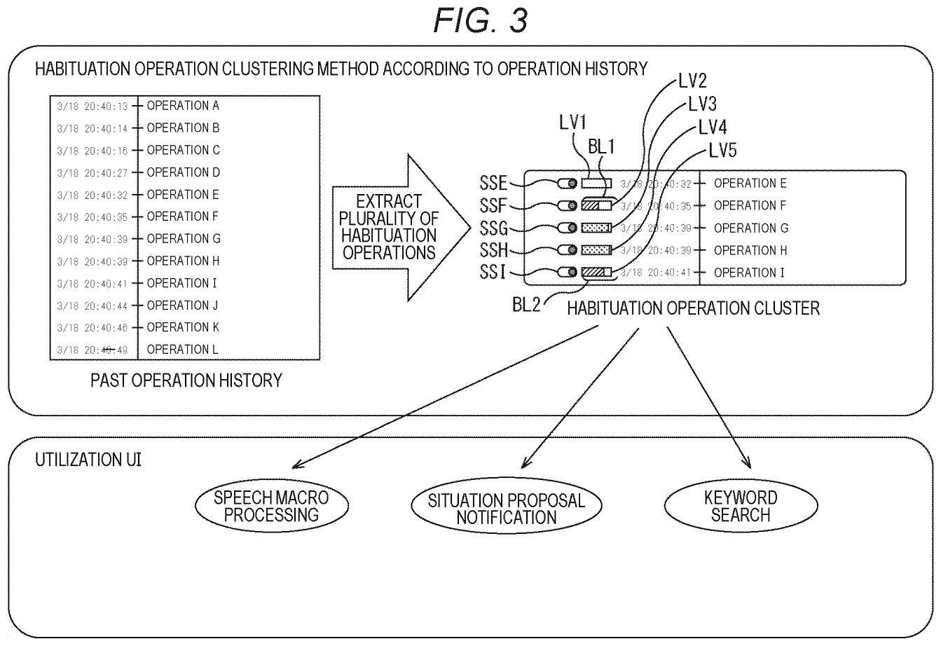

For example, the user operation history is recorded and presented as illustrated in the upper left part of FIG. 3, and the habituation operation cluster illustrated in the upper right part of FIG. 3 is set for a plurality of operations with a high degree of habituation operation in the user operation history.

Note that, in the user operation history in the upper left part of FIG. 3, from the top, it is indicated that an operation A is performed at 3/18 20:40:13, an operation B is performed at 3/18 20:40:14, an operation C is performed at 3/18 20:40:16, and an operation D is performed at 3/18 20:40:27.

Furthermore, it is indicated that an operation E is performed at 3/18 20:40:32, an operation F is performed at 3/18 20:40:35, an operation G is performed at 3/18 20:40:39, an operation H is performed at 3/18 20:40:39, and an operation I is performed at 3/18 20:40:41.

Moreover, it is indicated that an operation J is performed at 3/18 20:40:44, an operation K is performed at 3/18 20:40:46, and an operation L is performed at 3/18 20:40:49.

In the user operation history illustrated in the upper left part of FIG. 3, a habituation score indicating the degree of habituation of each operation is obtained in each user operation history, which is a part of the user operation history. Two or more operations having habituation scores higher than a predetermined value are clustered and set as a habituation operation cluster as illustrated in the upper right part of FIG. 3.

The upper right part of FIG. 3 is an example of a habituation operation cluster including two or more operations having the habituation score higher than a predetermined value.

In the upper right part of FIG. 3, since the operations are two or more operations in which the habituation scores of the operations F to I are higher than a predetermined value, the operations are clustered as a habituation operation cluster.

Furthermore, in the habituation operation cluster, the operation E immediately preceding two or more operations in which the habituation score is higher than the predetermined value is also included in the habituation operation cluster.

Therefore, in the upper right part of FIG. 3, the operations E to I are included as the habituation operation cluster.

For the habituation operation cluster in the upper right part of FIG. 3, score display fields LV1 to LV5 indicating the degree of the selected habituation score are displayed on the left side of each of the operations E to L.

In each of the score display fields LV1 to LV5, a bar graph extending in the right direction in the drawing is illustrated as the habituation score is higher, and the bar graph is colored according to the habituation score and displayed.

That is, in the upper right part of FIG. 3, it is indicated that the habituation scores of the score display fields LV3 and LV4 of the operations G and H are the highest, and the habituation scores of the score display fields LV2 and LV5 of the operations F and I are the second highest.

Furthermore, in the upper right part of FIG. 3, score display fields LV2 to LV5 of operations having a habituation score higher than a predetermined threshold are displayed sandwiched between brackets BL1 and BL2.

With the display of the brackets BL1 and BL2, it is possible to visually confirm that there are operations F to I including two or more operations having the habituation score higher than a predetermined value, and that a habituation operation cluster is formed together with the operation E immediately preceding the operations F to I.

Moreover, in the operations E to I, switches SSE to SSI are provided on the left sides of each of the score display fields LV1 to LV5, and it is possible to select an operation to be registered when macro processing is performed by operating each of the switches.

That is, as illustrated in the upper left part and the upper right part of FIG. 3, a habituation operation cluster based on the user operation history is set. Therefore, a plurality of operations having a high degree of habituation are subjected to macro processing, and are stored in association with a phrase, and thereby, macro registration processing is performed, and speech macroscopic processing is achieved (speech macro processing in the lower part of FIG. 3).

As a result, the user can collectively perform a plurality of operations having a high degree of habituation by uttering the registered phrase.

Furthermore, as illustrated in the lower part of FIG. 3, by presenting a habituation operation cluster including a plurality of operations having a habituation score higher than a predetermined value, a habituation situation including a plurality of consecutive operations is presented to the user, and a situation proposal notification for determining whether or not to perform macro processing is presented (situation proposal notification in the lower part of FIG. 3).

As a result, the user can be conscious of a plurality of his/her habitual consecutive operations, and can subject a plurality of consecutive operations having a high habituation score to macro processing and register the operations at the timing when the user recognizes that the habituation score has increased to some extent.

Moreover, as illustrated in the lower part of FIG. 3, searching for the habituation operation cluster including the keyword uttered by the user is performed and the habituation operation cluster is presented (keyword search in the lower part of FIG. 3).

As a result, even if the user forgets the phrase macro-registered in association with the habituation operation cluster, the habituation operation cluster that is searched for on the basis of a related phrase is presented and the collective execution is proposed, so that the macro-registered habituation operation cluster can be utilized.

However, even after macro registration of the habituation operation cluster, the habituation operation may change.

In such a case, when the above-described method is used, even if the habituation operation is changed, it takes time until the habituation operation is recognized as a new habituation operation. Therefore, there is a possibility that it takes time until a habituation operation cluster corresponding to the new habituation operation is generated.

Therefore, in the present disclosure, by estimating the habituation operation from the past operation history of the user, the dialog with the user is implemented at the timing when the operation that needs to be changed is performed among the plurality of macro operations, and the operation can be easily changed according to the dialog.

### 2. Preferred Embodiments

Next, preferred embodiments of the present disclosure will be described.

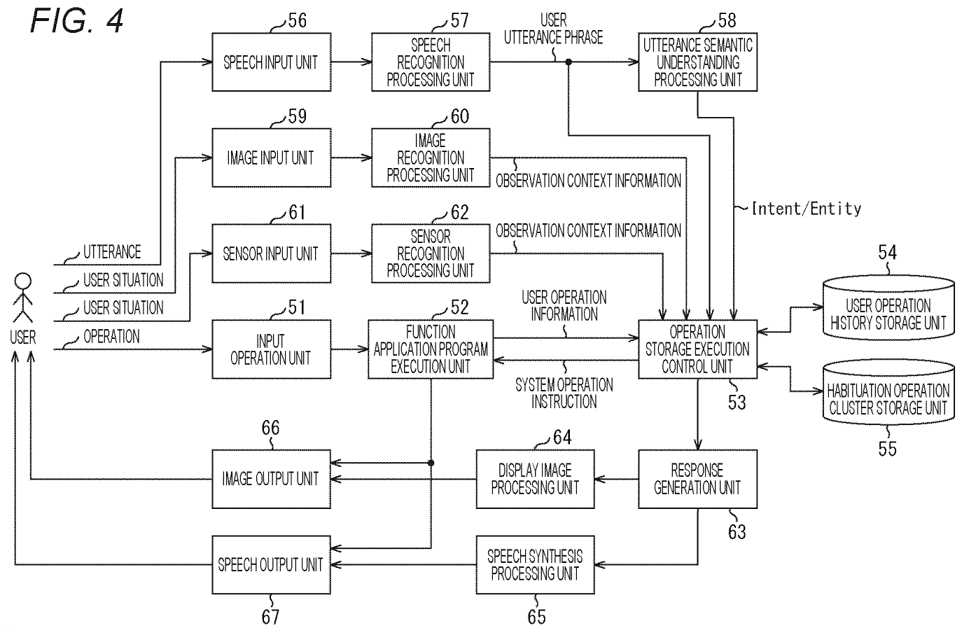

FIG. 4 illustrates a preferred embodiment of an information processing apparatus to which the technology of the present disclosure is applied.

An information processing apparatus 41 in FIG. 4 includes an input operation unit 51, a functional application program execution unit 52, an operation storage execution control unit 53, a user operation history storage unit 54, a habituation operation/dialog cluster storage unit 55, a speech input unit 56, a speech recognition processing unit 57, an utterance semantic understanding processing unit 58, an image input unit 59, an image recognition processing unit 60, a sensor input unit 61, a sensor recognition processing unit 62, a response generation unit 63, a display image processing unit 64, a speech synthesis processing unit 65, an image output unit 66, and a speech output unit 67.

The input operation unit 51 includes a keyboard, a mouse, a touch panel (input operation device), and the like, receives an operation input of a user, generates an operation signal corresponding to the received operation input, and outputs the operation signal to the functional application program execution unit 52.

On the basis of the operation signal supplied from the input operation unit 51 and the system operation instruction supplied from the operation storage execution control unit 53, the functional application program execution unit 52 executes an application program that implements various functions such as presenting content supplied from a web browser or an accessed site, for example.

More specifically, the functional application program execution unit 52 implements functions as a general operation of a game (controller), a television (remote controller), a music/video player, a smartphone/tablet, a personal computer (PC), and the like, and a general device having a plurality of operation functions of an augmented reality (AR)/virtual reality (VR) device, a home appliance, a camera/camcorder, a business system, and others.

Note that, in the following description, an example in which the functional application program execution unit 52 functions as a web browser will be described. However, as a matter of course, the functional application program execution unit 52 may implement a function of another device.

Furthermore, the functional application program execution unit 52 outputs an image including a moving image and a still image constituting an execution result based on the operation signal supplied from the input operation unit 51 and the system operation instruction supplied from the operation storage execution control unit 53 to the image output unit 66.

Moreover, the functional application program execution unit 52 outputs a speech constituting an execution result based on the operation signal supplied from the input operation unit 51 and the system operation instruction supplied from the operation storage execution control unit 53 to the speech output unit 67.

The speech input unit 56 includes a microphone or the like, receives an input of an utterance phrase including a speech uttered by the user, generates a corresponding speech signal, and outputs the generated speech signal to the speech recognition processing unit 57.

The speech recognition processing unit 57 performs speech recognition processing (automatic speech recognition (ASR)) on the basis of the speech signal supplied from the speech input unit 56, and outputs a speech recognition result including a text to the utterance semantic understanding processing unit 58 and the operation storage execution control unit 53.

The utterance semantic understanding processing unit 58 applies utterance semantic understanding processing (natural language understanding (NLU)) to the speech recognition result including the text supplied from the speech recognition processing unit 57, and estimates an utterance intent (operation type) (Intent) of the utterance phrase of the user and attribute information (Entity) that is a target of the utterance.

The utterance semantic understanding processing unit 58 outputs an utterance intent (operation type) (Intent) of the utterance phrase of the user that is an estimation result and attribute information (Entity) that is a target of the utterance to the operation storage execution control unit 53.

The image input unit 59 includes a camera or the like, receives an input of an expression that is a situation of the user and a surrounding image, generates a corresponding image signal, and outputs the generated image signal to the image recognition processing unit 60.

The image recognition processing unit 60 performs image recognition processing on the image signal supplied from the image input unit 59, and outputs the processing result to the operation storage execution control unit 53 as observation context information indicating the situation of the user.

The sensor input unit 61 includes a global positioning system (GPS) sensor, a pulse sensor, a blood pressure sensor, and the like, receives an input of a sensing result of each sensor, generates a corresponding sensor signal, and outputs the sensor signal to the sensor recognition processing unit 62.

The sensor recognition processing unit 62 performs sensor recognition processing on the sensor signal supplied from the sensor input unit 61, and outputs the processing result to the operation storage execution control unit 53 as observation context information indicating the situation of the user.

The operation storage execution control unit 53 adds a time stamp to the user operation information supplied from the functional application program execution unit 52, stores the user operation information in the user operation history storage unit 54 as a user operation history, and accumulates the user operation information as a user operation history.

The operation storage execution control unit 53 may cause the display image processing unit 64 to generate a specific history management screen or the like via the response generation unit 63, and cause the image output unit 66 to display the user operation history stored in the user operation history storage unit 54 in time series as the past user operation history described with reference to the upper left part of FIG. 3, for example, so that the user can browse the user operation history.

The user operation information is information corresponding to the operation content of the input operation unit 51, and for example, in a case where the function implemented by the functional application program execution unit 52 is a web browser, the user operation information is information corresponding to operations such as clicking, form input, form submit, and site transition.

Moreover, the user operation information also includes information of a user interface (UI) component such as a link/form to be operated and information of a transition destination uniform resource locator (URL) (+ title of site).

Furthermore, the user operation information includes information on the URL of the site (+ title of the site) when the operation is performed by the input operation unit 51.

The operation storage execution control unit 53 estimates a plurality of user's habitual operations (combined operations) as a habituation operation cluster or a dialog cluster on the basis of the past user operation history accumulated in the user operation history storage unit 54, and stores the results in the habituation operation/dialog cluster storage unit 55. The operation storage execution control unit 53 reads a corresponding habituation operation cluster or dialog cluster from the habituation operation/dialog cluster storage unit 55 on the basis of the utterance phrase of the user, the utterance intent (operation type) (Intent), the attribute information (Entity) that is a target of the utterance, the observation context information, and the user operation information.

Then, the operation storage execution control unit 53 subjects the read habituation operation cluster or dialog cluster to speech macro processing, or performs collective execution of a plurality of operations, macro execution, or the like based on the habituation operation cluster or dialog cluster to generate a system operation instruction, and outputs the system operation instruction to the functional application program execution unit 52 to cause execution by the functional application program execution unit 52.

The functional application program execution unit 52 collectively executes a plurality of operations constituting a habituation operation cluster or a dialog cluster in time series on the basis of a system operation instruction corresponding to the habituation operation cluster or the dialog cluster.

Furthermore, for the purpose of the proposal notification and the confirmation dialog related to the speech macro processing and the execution of the habituation operation cluster or the dialog cluster, for the user, the operation storage execution control unit 53 controls the response generation unit 63 to generate and output a display image and a speech for proposal notification and confirmation dialog related to speech macro processing and collective execution of the habituation operation cluster, or the dialog cluster.

The response generation unit 63 causes the display image processing unit 64 to generate a display image for a proposal notification or a confirmation dialog related to the speech macro processing and the execution of the habituation operation cluster or the dialog cluster, and causes the speech synthesis processing unit 65 to generate a speech for a similar proposal notification or confirmation dialog.

The display image processing unit 64 outputs, to the image output unit 66, the generated display image for the proposal notification or the confirmation dialog related to the speech macro processing and execution of the habituation operation cluster or the dialog cluster, and causes the image output unit 66 to display the display image.

The speech synthesis processing unit 65 causes the speech output unit 67 to output the speech for the proposal notification or the confirmation dialog related to the speech macro processing and execution of the habituation operation cluster or the dialog cluster.

The image output unit 66 includes a display, a projector, and the like, and is controlled by the functional application program execution unit 52 to display a display image as a processing result of the functional application program execution unit 52.

Furthermore, the image output unit 66 displays the display image supplied from the display image processing unit 64.

The speech output unit 67 includes a speaker, a headphone, and the like, and is controlled by the functional application program execution unit 52 to output a speech as a processing result of the functional application program execution unit 52.

Furthermore, the speech output unit 67 outputs the speech supplied from the speech synthesis processing unit 65.

<Habituation Score Corresponding to User Operation Information>

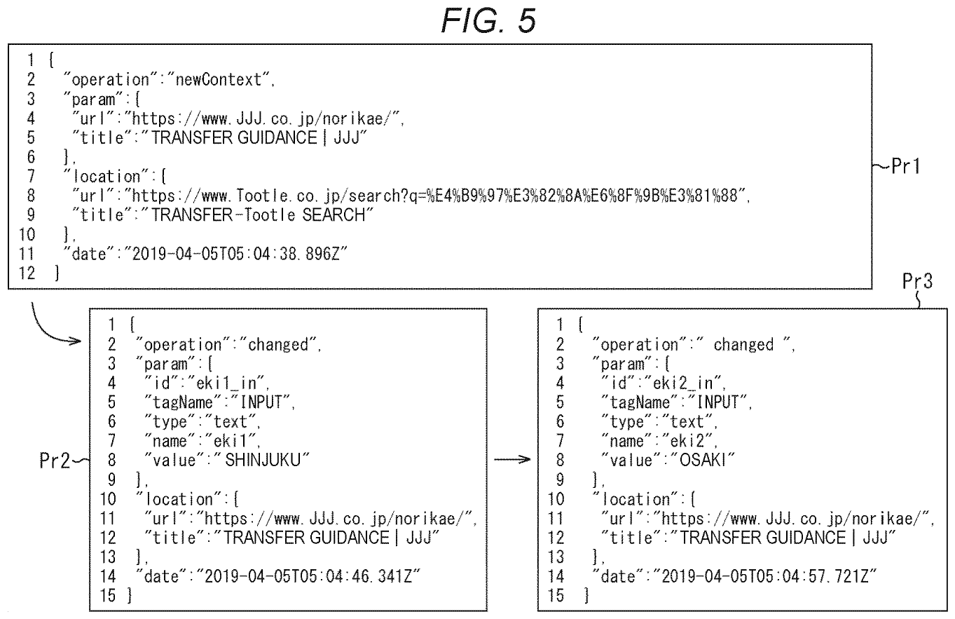

Next, the habituation score corresponding to the user operation information will be described with reference to FIG. 5.

The user operation information is accumulated as, for example, information such as user operation information Pr1 to Pr3 in FIG. 5.

That is, the user operation information Pr1 of FIG. is configured by descriptions in the lines 1 to 12, and the lines 2 to 6 indicate that an operation to display the homepage of the URL transfer guidance indicated by “url”: “https://www.JJJ.co.jp/norikae/” and “title”: “transfer guidance |JJJ” is performed.

Furthermore, the lines 7 to 10 of the user operation information Pr1 of FIG. 5 indicate that information stored at the location indicated by “url”: “https://www.tootle.co.jp/search?q=%E4%B9%97%E3%82%8A%E6% 8F%9B%E3%81%88”, “title”: “TRANSFER-Tootle SEARCH” on the network is read and displayed.

Moreover, the line 11 of the user operation information Pr1 in FIG. 5 indicates that the operation of the user operation information ST1 has been performed at the time 05:04:38.896 on Apr. 5, 2019, as indicated by “date”: “2019-04-05T05:04:38.896Z”.

Then, by the operation of the user operation information Pr1, information on the operation of inputting the station name of the getting-on station in the displayed webpage of the transfer guidance is described by the user operation information Pr2.

That is, the user operation information Pr2 in FIG. includes descriptions of the lines 1 to 15, and lines 2 to 9 indicate that an operation to input Shinjuku as a getting-on station has been performed.

Furthermore, lines 10 to 13 of the user operation information Pr2 of FIG. 5 indicate that information stored at the location indicated by “url”: “https://www.JJJ.co.jp/norikae/”, “title”: “transfer guidance|JJJ on the network is read and displayed.

Moreover, the line 14 of the user operation information Pr2 in FIG. 5 indicates that the operation of the user operation information ST2 has been performed at the time 05:04:46.341 on Apr. 5, 2019, as indicated by “date”: “2019-04-05T05:04:46.341Z”.

Furthermore, by the operation of the user operation information Pr1, information on the operation of inputting the station name of the getting-off station in the displayed webpage of the transfer guidance is described by the user operation information Pr3.

That is, the user operation information Pr3 in FIG. 5 includes descriptions of the lines 1 to 15, and lines 2 to 9 indicate that an operation to input Osaki as a getting-off station has been performed.

Furthermore, lines 10 to 13 of the user operation information Pr3 of FIG. 5 indicate that information stored at the location indicated by “url”: “https://www.JJJ.co.jp/norikae/”, “title”: “transfer guidance|JJJ on the network is read and displayed.

Moreover, the line 14 of the user operation information Pr3 in FIG. 5 indicates that the operation of the user operation information ST3 has been performed at the time 05:04:57.721 on Apr. 5, 2019, as indicated by “date”: “2019-04-05T05:04:57.721Z”.

That is, the user operation information Pr1 to Pr3 of FIG. 5 is sequentially accumulated in the user operation history storage unit 54 in time series.

When the user operation information is supplied, the operation storage execution control unit 53 sequentially accumulates the user operation information in the user operation history storage unit 54 to configure a user operation history.

Furthermore, when the user operation information is supplied, the operation storage execution control unit 53 calculates a habituation score using the user operation history accumulated in the user operation history storage unit 54, accumulates the habituation score in association with the user operation history, and sequentially updates the habituation score.

Here, the habituation score is, for example, a value indicating a tendency of the habituation with respect to the past user operation history of an operation n corresponding to the n-th operation on the user operation history, and is a score defined by the following Equation (1).

Sₙ=3/(1/Tₙ+1/Fₙ+1/Pₙ) (1)

Here, Sₙ is a habituation score of the operation n, Tₙ is a time interval from the previous operation n−1 to the operation n, Fₙ is the number of transitions from the operation n−1 to the operation n, and Pₙ is a transition probability from the operation n−1 to the operation n.

That is, the habituation score of the operation n is a harmonic average of the time interval Tₙ from the previous operation n−1 to the operation n, the number of transitions Fₙ from the operation n−1 to the operation n, and the transition probability Pₙ from the operation n−1 to the operation n.

Furthermore, the time interval Tₙ from the previous operation n−1 to the operation n is defined by the following Equation (2).

Tₙ=Hₜ/((tₙ−t₍ₙ₋₁₎)+Hₜ) (2)

Here, Tₙ is a time interval from the previous operation n−1 to the operation n, tₙ is a time when the operation n is performed, t₍ₙ₋₁₎ is a time when the operation n−1 is performed, and Hₜ is a normalization constant. The normalization constant Hₜ may be, for example, 30 seconds.

Note that the normalization constant Hₜ may be made variable by the user. That is, in the time interval Tₙ, the influence of the time difference changes depending on the normalization constant H_{c}. For this reason, for example, a person who is accustomed to the operation and a person who is not accustomed to the operation may be determined from the average value of the use time and the operation time interval of the device, and the normalization constant Hₜ may be decreased for the person who is accustomed to the operation and the normalization constant Hₜ may be increased for the person who is not accustomed to the operation.

Moreover, the number of transitions Fₙ from the operation n−1 to the operation n is defined by the following Equation (3).

Fₙ=1−H_{c}/(Cₜₙ+H_{c}) (3)

Here, Cₜₙ is the number of times of transition from the same operation as the operation n−1 to the same operation as the operation n in the past on the user operation history, and H_{c} is a normalization constant. The normalization constant H_{c} is, for example, three times.

Furthermore, the transition probability Pₙ from the operation n−1 to the operation n is defined by the following Equation (4).

Pₙ=Cₜₙ/C₍ₙ₋₁₎ (4)

Here, C₍ₙ₋₁₎ is the number of times the same operation as the operation n−1 has been performed in the past on the user operation history.

That is, the habituation score Sₙ of the operation n is determined to be habitually performed and the score becomes higher as the operation n is performed within a shorter time than the previous operation n−1 and the number of transitions Fₙ and the transition probability Pₙ become higher.

When the user operation information is supplied and is newly accumulated in the user operation history in the user operation history storage unit 54, the operation storage execution control unit 53 sequentially calculates the above-described habituation score Sₙ, stores the calculated scores for each operation accumulated in the user operation history, and updates the scores as necessary.

More specifically, when there are two or more operations having the habituation score Sₙ larger than a habituation threshold Sₜₕ (for example, 0.5) on the time series of the operation history, the operation storage execution control unit 53 sets, as the habituation operation cluster candidate, operations from the first operation immediately preceding the operation having the habituation score Sₙ larger than the habituation threshold Sₜₕ to the last operation having the habituation score Sₙ larger than the habituation threshold Sₜₕ.

Next, in a case where there is no habituation operation cluster having the same sequence as that of the habituation operation cluster candidate (the order is matched with that of the operation in the habituation operation cluster) in the habituation operation clusters stored in the habituation operation/dialog cluster storage unit 55, and there is no habituation operation cluster having the same operation and different order from that of the habituation operation cluster, the operation storage execution control unit 53 stores the habituation operation cluster candidate as a new habituation operation cluster in the habituation operation/dialog cluster storage unit 55.

Furthermore, in a case where there is a habituation operation cluster having the same operation as that of the habituation operation cluster candidate and different order from that of the habituation operation cluster candidate in the habituation operation clusters stored in the habituation operation/dialog cluster storage unit 55, the operation storage execution control unit 53 compares the habituation operation cluster candidate with the habituation operation cluster, detects and integrates the order variable operation in the habituation operation cluster, and updates and stores the result in the habituation operation/dialog cluster storage unit 55 as the habituation operation cluster.

Furthermore, when there are two or more operations having the habituation score Sₙ larger than a habituation threshold Sₜₕ (for example, 0.5) on the time series of the operation history, the operation storage execution control unit 53 sets, as the dialog cluster candidate, operations from the first operation immediately preceding the operation having the habituation score Sₙ larger than the habituation threshold Sₜₕ to the last operation having the habituation score Sₙ larger than the habituation threshold Sₜₕ.

Furthermore, in a case where there is no cluster included in the sequence of the dialog cluster candidate and there is no cluster that can be replaced by the dialog in the habituation operation cluster and the dialog cluster (hereinafter, the habituation operation cluster and the dialog cluster are also simply referred to as clusters) stored in the habituation operation/dialog cluster storage unit 55, the operation storage execution control unit 53 stores the dialog cluster candidate in the habituation operation/dialog cluster storage unit 55 as a new dialog cluster.

<Habituation Operation Clustering Processing>

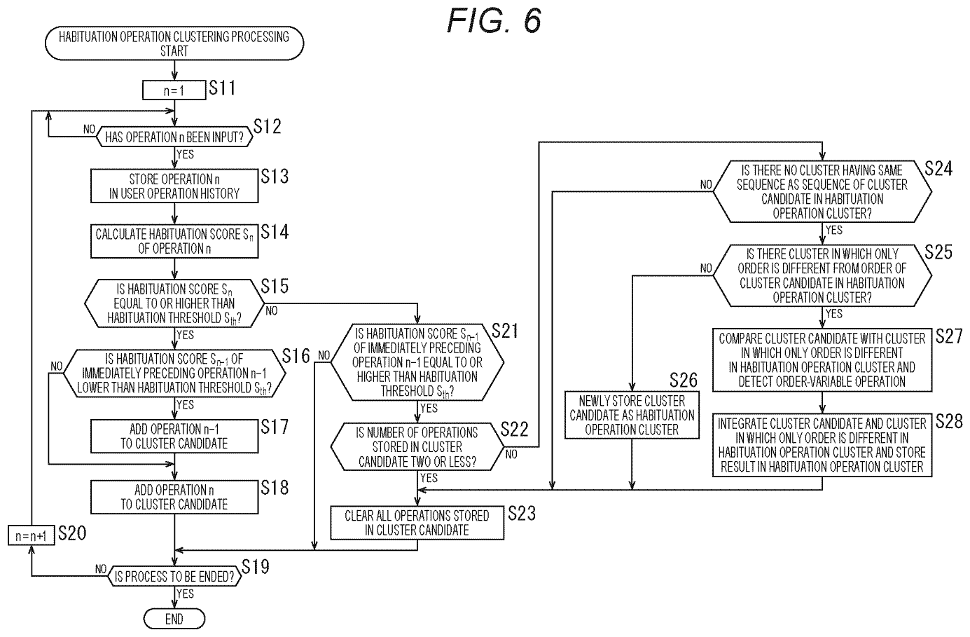

Next, the habituation operation clustering processing will be described with reference to the flowchart of FIG. 6.

In step S11, the operation storage execution control unit 53 initializes a counter n for counting operations to 1.

In step S12, the operation storage execution control unit 53 determines whether or not the user operation information of the operation n has been supplied, and repeats similar processing until the user operation information of the operation n is supplied.

Then, in step S12, in a case where the user operation information of the operation n is supplied, the processing proceeds to step S13.

In step S13, the operation storage execution control unit 53 imparts a time stamp to the user operation information of the operation n and causes the user operation history storage unit 54 to store the user operation information as a user operation history.

In step S14, the operation storage execution control unit 53 calculates the habituation score Sₙ of the operation n by the calculation described with reference to Equations (1) to (4) described above on the basis of the user operation history stored in the user operation history storage unit 54.

In step S15, the operation storage execution control unit 53 determines whether or not the habituation score Sₙ corresponding to the operation n is larger than the habituation threshold Sₜₕ.

In a case where it is determined in step S15 that the habituation score Sₙ corresponding to the operation n is larger than the habituation threshold Sₜₕ, the operation n is regarded as an operation having a high degree of habituation, and the process proceeds to step S16.

In step S16, the operation storage execution control unit 53 determines whether or not the habituation score Sₙ₋₁ of the operation n−1 immediately preceding the operation n is smaller than the habituation threshold Sₜₕ.

In step S16, in a case where the habituation score Sₙ₋₁ of the operation n−1 immediately preceding the operation n is smaller than the habituation threshold Sₜₕ, the process proceeds to step S17.

In step S17, the operation storage execution control unit 53 adds the operation n−1 to the habituation operation cluster candidate.

In step S18, the operation storage execution control unit 53 adds the operation n to the habituation operation cluster candidate.

In step S19, the operation storage execution control unit 53 determines whether or not an instruction to end the process is given, and in a case where the instruction to end the process is given, the process ends.

Furthermore, in a case where the instruction to end is not given in step S19, the process proceeds to step S20.

In step S20, the operation storage execution control unit 53 increments the counter n by 1, and the process returns to step S12.

That is, when the number of operations n having the habituation score Sₙ higher than the habituation threshold Sₜₕ is plural (repeated) until an instruction for the end of the habituation operation clustering processing is given, the processing of steps S11 to S20 are repeated, the counter n is sequentially incremented by 1, and the operation of the habituation operation cluster candidate is continuously added.

Furthermore, since the first operation of the operation constituting the habituation operation cluster is the operation immediately preceding the operation having the habituation score Sₙ higher than the habituation threshold Sₜₕ, when the habituation score Sₙ₋₁ of the operation n−1 immediately preceding the operation n is lower than the habituation threshold Sₜₕ by the processing of step S16, the operation n−1 immediately preceding the operation n is included as the first operation of the habituation operation cluster candidate by the processing of step S17.

Accordingly, among the operations constituting the habituation operation cluster candidates, the habituation score Sₙ is larger than the habituation threshold Sₜₕ for operations other than the first operation, and thus, in step S16, the habituation score Sₙ is not smaller than the habituation threshold Sₜₕ, and thus, the processing of step S17 is skipped.

Moreover, in a case where it is determined in step S15 that the habituation score Sₙ corresponding to the operation n is not larger than the habituation threshold Sₜₕ, the operation n is regarded as not an operation having a high degree of habituation, and the process proceeds to step S21.

In step S21, the operation storage execution control unit 53 determines whether or not the habituation score Sₙ₋₁ of the operation n−1 immediately preceding the operation n is larger than the habituation threshold Sₜₕ.

In a case where it is regarded in step S21 that the habituation score Sₙ₋₁ of the operation n−1 is larger than the habituation threshold Sₜₕ, the operation up to the immediately preceding operation is regarded as a part of the operation included in the habituation operation cluster candidate, and the process proceeds to step S22.

Note that, in a case where it is regarded in step S21 that the habituation score Sₙ₋₁ of the operation n−1 is smaller than the habituation threshold Sₜₕ, the immediately preceding operation is regarded as not the operation included in the habituation operation cluster candidate, and the process proceeds to step S19.

In step S22, the operation storage execution control unit 53 determines whether or not the operation included in the habituation operation cluster candidate configured by the operations up to the immediately preceding operation is two or less.

Since it is assumed that the habituation operation cluster is three or more, in a case where the number of operations included in the habituation operation cluster candidate configured by the operations up to the immediately preceding operation is two or less in step S22, it is considered that the habituation operation cluster is not configured, and the process proceeds to step S23.

Then, in step S23, the operation storage execution control unit 53 clears the information on the operation stored as the habituation operation cluster candidate, and the process proceeds to step S19.

Furthermore, in a case where the number of operations included in the habituation operation cluster candidate configured by the operations up to the immediately preceding operation is not two or less in step S22, since it is considered that the habituation operation cluster candidate includes three or more operations, the process proceeds to step S24.

In step S24, the operation storage execution control unit 53 determines whether or not there is the completely same cluster having the same operation as the operation included in the habituation operation cluster candidate currently being processed and the sequence is the same (the order of the sequence is the same) as that of the habituation operation cluster candidate currently being processed, among the already-registered habituation operation clusters stored in the habituation operation/dialog cluster storage unit 55.

That is, in a case where the habituation operation cluster candidate is completely the same as the habituation operation cluster already registered in the habituation operation/dialog cluster storage unit 55, it is not necessary to newly register the cluster. Therefore, it is determined whether or not there is completely the same cluster.

In step S24, in a case where there is the completely same habituation operation cluster as the habituation operation cluster candidate currently being processed in the already-registered habituation operation clusters stored in the habituation operation/dialog cluster storage unit 55, the process proceeds to step S23.

That is, in this case, since there is the completely same habituation operation cluster as the habituation operation cluster candidate currently being processed in the already-registered habituation operation clusters stored in the habituation operation/dialog cluster storage unit 55, the process proceeds to step S23, and the information on the habituation operation cluster candidate currently being processed is cleared.

Furthermore, in step S24, in a case where there is no cluster that is the completely same as the habituation operation cluster candidate currently being processed in the already-registered habituation operation clusters stored in the habituation operation/dialog cluster storage unit 55, the process proceeds to step S25.

In step 25, the operation storage execution control unit 53 determines whether or not there is a habituation operation clusters having the same operation as that included in the habituation operation cluster candidate currently being processed but the order of the operation is not the same as that of the habituation operation cluster candidate currently being processed among the already-registered habituation operation clusters stored in the habituation operation/dialog cluster storage unit 55, that is, determines whether or not there is a habituation operation cluster in which an operation is the same but only the order is different.

Furthermore, in step S25, in a case where there is no habituation operation cluster in which an operation is the same as that included in the habituation operation cluster candidate currently being processed but only the order is different in the already-registered habituation operation clusters stored in the habituation operation/dialog cluster storage unit 55, the process proceeds to step S26.

In step S26, the operation storage execution control unit 53 registers the operation of the habituation operation cluster candidate currently being processed in the habituation operation/dialog cluster storage unit 55 as a new habituation operation cluster in the order as it is.

That is, since there is no habituation operation cluster in which an operation is the same as that included in the habituation operation cluster candidate currently being processed and only the order is different among the already-registered habituation operation clusters stored in the habituation operation/dialog cluster storage unit 55, the habituation operation cluster candidate currently being processed is regarded as a habituation operation cluster including a plurality of new operations, and is registered in the habituation operation/dialog cluster storage unit 55.

Furthermore, in step S25, in a case where there is a habituation operation cluster in which an operation is the same as that included in the habituation operation cluster candidate currently being processed but the order of the operation is not the same, that is, only the order is different in the already-registered habituation operation clusters stored in the habituation operation/dialog cluster storage unit 55, the process proceeds to step S27.

In step S27, the operation storage execution control unit 53 compares the habituation operation cluster candidate currently being processed with the registered habituation operation cluster in which an operation is the same as the operation included in the habituation operation cluster candidate currently being processed but the order is not the same as the order of the operation included in the habituation operation cluster candidate currently being processed, and detects an operation whose order is variable. Hereinafter, this is also referred to as detection of an order-variable operation.

In step S28, the operation storage execution control unit 53 integrates the habituation operation cluster candidate currently being processed with the registered habituation operation cluster in which an operation is the same as the operation included in the habituation operation cluster candidate currently being processed but the order is not the same as the order of the operation included in the habituation operation cluster candidate currently being processed, together with information on a variable range of the order-variable operation, and registers the result in the habituation operation/dialog cluster storage unit 55 as one habituation operation cluster.

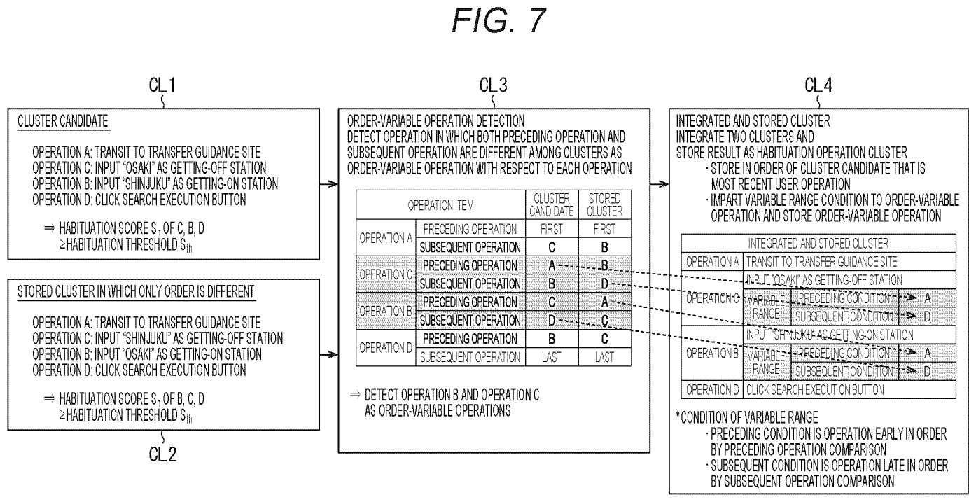

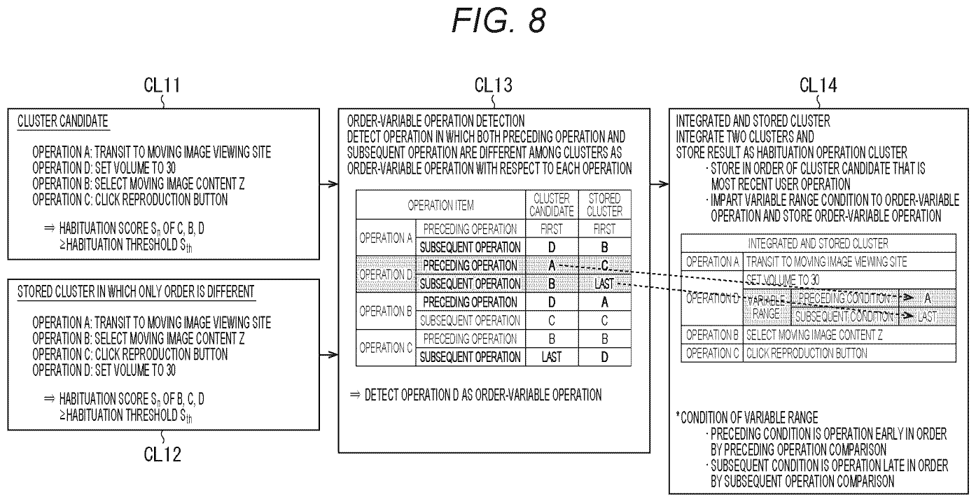

Note that comparison and integration of habituation operation clusters will be described later in detail with reference to FIGS. 7 and 8.

When a new operation n is received by the above processing, the habituation score Sₙ is sequentially obtained and compared with the habituation threshold Sₜₕ so that the habituation operation cluster candidate is set.

Furthermore, by comparing the operation constituting the habituation operation cluster candidate with the operation constituting the already-registered habituation operation clusters, a habituation operation cluster candidate including an operation completely different from that of the already-registered habituation operation cluster is registered as a new habituation operation cluster.

Moreover, by comparing the operation constituting the habituation operation cluster candidate and the operation constituting the already-registered habituation operation cluster, a habituation operation cluster candidate including the same operation but different only in the operation order is integrated with the registered habitual operation cluster as one habituation operation cluster and registered in the habituation operation/dialog cluster storage unit 55.

As a result, it is possible to sequentially register a plurality of operations having high habituation scores and high degree of habituation as operations of the user as a habituation operation cluster.

Note that, since there is a possibility that the habituation deviates from the registered habituation operation cluster with the lapse of time, it may be set such that the habituation operation cluster registered for a predetermined period or more is deleted.

<Comparison and Integration of Habituation Operation Clusters (Part 1)>

Here, comparison and integration of habituation operation clusters will be described with reference to FIG. 7.

As the habituation operation cluster candidate and the registered habituation operation cluster, for example, consider a case where there are a habituation operation cluster candidate CL1 as illustrated in FIG. 7 and a habituation operation cluster CL2 different only in the order.

Here, the habituation operation cluster candidate CL1 in FIG. 7 includes four operations of operations A to D, and the habituation operation cluster CL2 similarly includes four operations A to D.

Here, in the habituation operation cluster candidate CL1, the operation is performed in the order of the operation A, the operation C, the operation B, and the operation D, while in the registered habituation operation cluster, the operation is performed in the order of the operation A, the operation B, the operation C, and the operation D.

Note that the operation A is an operation of transitioning to a transfer guidance site, the operation C is an operation of inputting “Osaki” as a getting-off station, the operation B is an operation of inputting “Shinjuku” as a getting-on station, and the operation D is an operation of clicking a search execution button.

Furthermore, it is assumed that, in both the habituation operation cluster candidate CL1 and the habituation operation cluster CL2, the habituation score Sₙ of each of the operation B, the operation C, and the operation D is larger than the habituation threshold Sₜₕ.

That is, comparing the operations of the habituation operation cluster candidate CL1 and the habituation operation cluster CL2, the order of the operation B that is the input operation of the getting-on station and the operation C that is the input operation of the getting-off station is different.

However, even if the order of the operation B that is the input operation of the getting-on station and the operation C that is the input operation of the getting-off station is different, the same transfer guidance is displayed by performing the final operation D. Therefore, the habituation operation cluster candidate CL1 and the habituation operation cluster CL2 are substantially the same, and it is desirable that they are integrated and handled as the same habituation operation cluster.

Therefore, as indicated by the comparison result CL3 in FIG. 7, the operation storage execution control unit 53 compares the operations before and after each operation constituting the habituation operation cluster candidate CL1 and the habituation operation cluster CL2.

That is, in the operation A of the habituation operation cluster candidate CL1, since the operation A is the first operation, there is no preceding operation (denoted as the first in the drawing), and the subsequent operation is the operation C.

In the operation C of the habituation operation cluster candidate CL1, the preceding operation is the operation A, and the subsequent operation is the operation B.

In the operation B of the habituation operation cluster candidate CL1, the preceding operation is the operation C, and the subsequent operation is the operation D.

Then, in the operation D of the habituation operation cluster candidate CL1, the preceding operation is the operation B, the operation D itself is the last operation, and there is no subsequent operation (the subsequent operation is described as a last in the drawing).

Furthermore, in the operation A of the habituation operation cluster CL2, since the operation A is the first operation, there is no preceding operation (denoted as the first in the drawing), and the subsequent operation is the operation B.

In the operation C of the habituation operation cluster CL2, the preceding operation is the operation B, and the subsequent operation is the operation D.

In the operation B of the habituation operation cluster CL2, the preceding operation is the operation A, and the subsequent operation is the operation C.

Then, in the operation D of the habituation operation cluster CL2, the preceding operation is the operation C, the operation D itself is the last operation, and there is no subsequent operation (the subsequent operation is described as last in the drawing).

Here, the operation storage execution control unit 53 detects an operation in which both the preceding operation and the subsequent operation are different between the habituation operation cluster candidate CL1 and the habituation operation cluster CL2 as the order-variable operation on the basis of the comparison result CL3 of FIG. 7.

That is, in the comparison result CL3 of FIG. 7, the operation B and the operation C among the operations are detected as the order-variable operation since both the preceding operation and the subsequent operation are different.

Note that the operation A is the first operation in both the habituation operation cluster candidate CL1 and the habituation operation cluster CL2, and furthermore, the operation D is the last operation in both the habituation operation cluster candidate CL1 and the habituation operation cluster CL2. Therefore, neither the operation A nor the operation D is an order-variable operation.

Therefore, the operation storage execution control unit 53 generates an integrated storage cluster CL4 as illustrated in FIG. 7 in which the habituation operation cluster candidate CL1 and the habituation operation cluster CL2 are integrated on the basis of the detected order-variable operation, and registers the integrated storage cluster CL4 in the habituation operation/dialog cluster storage unit 55.

That is, in the integrated storage cluster CL4 in FIG. 7, the fact is recorded that, from the left, the operation A is an operation of transitioning to a transfer guidance site, the operation C is an operation of inputting “Osaki” as a getting-off station, the operation B is an operation of inputting “Shinjuku” as a getting-on station, and the operation D is an operation of clicking a search execution button.

Furthermore, among the operations, since the operation C and the operation B are detected as the order-variable operations, a variable range is set.

The variable range includes a preceding condition and a subsequent condition. An operation that can be a preceding operation of an operation and is the earliest in order is set as the preceding condition, and an operation that can be a subsequent operation and is the latest in order is set as the subsequent condition.

In the integrated storage cluster CL4 of FIG. 7, since the operation C and the operation B are detected as order-variable operations, the operation C and the operation B are set such that the preceding condition is the operation A and the subsequent condition is the operation D, as indicated by arrows in the drawing.

That is, according to the information of the integrated storage cluster CL4 in FIG. 7, it is recorded that the order can be varied as long as both the operation C and the operation B are in the range between the operation A and the operation D, that is, in the variable range.

Note that, in the integrated storage cluster CL4 of FIG. 7, an example is illustrated in which registration is performed in the order of the operations performed most recently. However, registration may be performed in the order of the operation of the registered habituation operation cluster.

<Comparison and Integration of Habituation Operation Clusters (Part 2)>

In the above description, in the comparison between the habituation operation cluster candidate and the registered habituation operation cluster, there are two operations with different preceding operation and subsequent operation, and a variable range is set for each operation.

However, the number of the order-variable operations may be a number other than two, for example, may be only one.

For example, as the habituation operation cluster candidate and the registered habituation operation cluster, for example, consider a case where there are a habituation operation cluster candidate CL11 as illustrated in FIG. 8 and a habituation operation cluster CL12 different only in the order.

Here, the habituation operation cluster candidate CL11 in FIG. 8 includes four operations of operations A to D, and the habituation operation cluster CL12 similarly includes four operations A to D.

Here, in the habituation operation cluster candidate CL11, the operation is performed in the order of the operation A, the operation D, the operation C, and the operation B, while in the registered habituation operation cluster, the operation is performed in the order of the operation A, the operation B, the operation C, and the operation D.

Note that the operation A is an operation of transitioning to a moving image browsing site, the operation D is an operation of setting the volume to 30, the operation B is an operation of selecting the moving image content Z, and the operation C is an operation of clicking the reproduction button.

Furthermore, in both the habituation operation cluster candidate CL11 and the habituation operation cluster CL12, the habituation score Sₙ of each of the operation B, the operation C, and the operation D is larger than the habituation threshold Sₜₕ.

That is, when the operations of the habituation operation cluster candidate CL11 and the habituation operation cluster CL12 are compared with each other, the operation D that is the operation of setting the volume to 30 is the order-variable operation between the operation A and the operation B.

However, regarding the operation D that is the operation of setting the volume to 30, even if the order is different, the volume is set to 30. Therefore, the habituation operation cluster candidate CL11 and the habituation operation cluster CL12 are substantially the same, and it is desirable that they are integrated and handled as the same habituation operation cluster.

Therefore, as indicated by the comparison result CL13 in FIG. 8, the operation storage execution control unit 53 compares the operations before and after each operation constituting the habituation operation cluster candidate CL11 and the habituation operation cluster CL12.

That is, in the operation A of the habituation operation cluster candidate CL11, since the operation A is the first operation, there is no preceding operation (denoted as the first in the drawing), and the subsequent operation is the operation D.

In the operation D of the habituation operation cluster candidate CL11, the preceding operation is the operation A, and the subsequent operation is the operation B.

In the operation B of the habituation operation cluster candidate CL11, the preceding operation is the operation D, and the subsequent operation is the operation C.

Then, in the operation C of the habituation operation cluster candidate CL11, the preceding operation is the operation B, the operation C itself is the last operation, and there is no subsequent operation (the subsequent operation is described as last in the drawing).

Furthermore, in the operation A of the habituation operation cluster CL12, since the operation A is the first operation, there is no preceding operation (denoted as the first in the drawing), and the subsequent operation is the operation B.

In the operation D of the habituation operation cluster CL12, the preceding operation is the operation C, the operation D itself is the last operation, and there is no subsequent operation (the subsequent operation is described as last in the drawing).

In the operation B of the habituation operation cluster CL12, the preceding operation is the operation A, and the subsequent operation is the operation C.

Then, in the operation C of the habituation operation cluster CL12, the preceding operation is the operation B, and the subsequent operation is the operation D.

Here, the operation storage execution control unit 53 detects an operation in which both the preceding operation and the subsequent operation are different between the habituation operation cluster candidate CL11 and the habituation operation cluster CL12 as the order-variable operation on the basis of the comparison result CL13 of FIG. 8.

That is, in the comparison result CL13 of FIG. 8, the operation D among the operations is detected as the order-variable operation since both the preceding operation and the subsequent operation are different.

Note that the operation A and the operation C have different subsequent operations, but have the same preceding operation. Furthermore, in the operation B, the preceding operation is different, but the subsequent operation is the same. Accordingly, none of the operation A, the operation B, and the operation C is detected as the order-variable operation.

Therefore, the operation storage execution control unit 53 generates an integrated storage cluster CL14 as illustrated in FIG. 8 in which the habituation operation cluster candidate CL11 and the habituation operation cluster CL12 are integrated on the basis of the detected order-variable operation, and registers the integrated storage cluster CL14 in the habituation operation/dialog cluster storage unit 55.

That is, in the integrated storage cluster CL14 in FIG. 8, the fact is recorded that, from the left, the operation A is an operation of transitioning to a moving image browsing site, the operation D is an operation of setting the volume to 30, the operation B is an operation of selecting the moving image content Z, and the operation C is an operation of clicking the reproduction button.

Furthermore, among the operations, since the operation D is detected as the order-variable operations, a variable range is set.

In the integrated storage cluster CL14 of FIG. 8, since the operation D is detected as an order-variable operation, the operation D is set such that the preceding condition is the operation A and the subsequent condition is the last, as indicated by arrows in the drawing.

That is, according to the information of the integrated storage cluster CL14 in FIG. 8, it is recorded that the order can be varied as long as both the operation D is in the range between the operation A and the last operation.

Note that, in the integrated storage cluster CL14 of FIG. 8, an example is illustrated in which registration is performed in the order of operations performed most recently. However, registration may be performed in the order of operations of the registered habituation operation cluster.

Through the above processing, among the registered habituation operation clusters, a habituation operation cluster candidate in which an operation is the same and only the order is different is integrated with the registered habituation operation cluster and registered as one habituation operation cluster (integrated storage cluster CL14).

At this time, the operation recognized as the order-variable operation can be set as a variable range in which the order of the operation can be made variable.

Through the above processing, the habituation operation cluster is sequentially registered in the habituation operation/dialog cluster storage unit 55, and the registered habituation operation cluster is presented to the user, and a plurality of operations constituting the habituation operation cluster is collectively performed or registered as a macro, so that execution of a plurality of operations with high degree of habituation is implemented.

<Dialog Cluster>

The habituation operation clustering processing based on the habituation operation has been described above. However, when the habituation operation changes after the habituation operation cluster is generated, various changes such as deletion and addition for the habituation operation cluster and change of the entity may be necessary.

Therefore, a cluster in which an operation based on a dialog with the user is included in at least a part of a plurality of operations constituting the cluster and collectively performed on the basis of the habituation operation so that the cluster can cope with a change in the habituation operation is a dialog cluster.

More specifically, the operation storage execution control unit 53 stores a dialog cluster having the following three types of operations in the habituation operation cluster as variables from the operation history, and generates a dialog on the basis of dialog information of variable operation stored in the dialog cluster to perform the operation constituting the cluster while appropriately changing the operation.

A first operation is an operation having the same operation type (Intent) and different attribute (Entity). For an operation having the same operation type (Intent) and different attribute (Entity), the operation storage execution control unit 53 sets a selection dialog flag f s as a flag indicating whether or not to perform a dialog when a corresponding operation is performed, and stores a plurality of input Entities in the dialog cluster together with the number of executions as option information Iₛ.

Furthermore, when a dialog cluster related to an operation having the same operation type (Intent) and different attribute (Entity) is performed, the operation storage execution control unit 53 presents options based on the input probability and makes an inquiry utterance of the Entity to be an option on the basis of the option information Iₛ according to the setting of the selection dialog flag fₛ, performs an operation on the basis of a user response, and updates the option information Iₛ.

A second operation is added and deleted operations. For added and deleted operations, the operation storage execution control unit 53 sets a confirmation dialog flag fₐ and stores the number of executions in the dialog cluster as confirmation information Iₐ.

Furthermore, when a dialog cluster related to an added or deleted operation is performed, the operation storage execution control unit 53 makes an inquiry utterance as to whether or not to perform the operation according to the setting of the confirmation dialog flag fₐ, performs the operation according to the user response, and updates the confirmation information Ia.

A third operation is an operation depending on an observation context. For an operation depending on an observation context, the operation storage execution control unit 53 sets a context dialog flag fc and stores the Entity matching the observation context in the dialog cluster as context information I_{c}.

Furthermore, when a dialog cluster related to an operation depending on an observation context is performed, the operation storage execution control unit 53 makes an inquiry utterance for the Entity in a case where the Entity does not match the observation context on the basis of the context information I_{c} according to the setting of the context dialog flag f_{c}, performs the operation according to the user response, and updates the context information I_{c}.

(Dialog Clustering Processing)

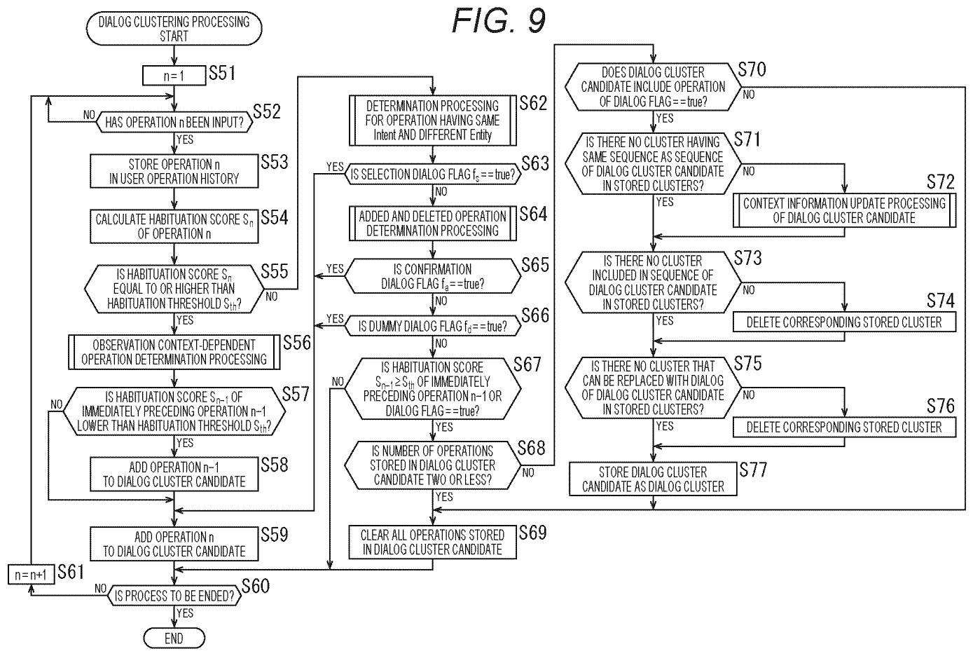

Next, in order to describe the processing for generating the dialog cluster, the dialog clustering processing will be described with reference to the flowchart of FIG. 9.

In step S51, the operation storage execution control unit 53 initializes a counter n for counting operations to 1.

In step S52, the operation storage execution control unit 53 determines whether or not the user operation information of the operation n has been supplied, and repeats similar processing until the user operation information of the operation n is supplied.

Then, in step S52, in a case where the user operation information of the operation n is supplied, the processing proceeds to step S53.

In step S53, the operation storage execution control unit 53 imparts a time stamp to the user operation information of the operation n and causes the user operation history storage unit 54 to store the user operation information as a user operation history.

In step S54, the operation storage execution control unit 53 calculates the habituation score Sₙ of the operation n by the calculation described with reference to Equations (1) to (4) described above on the basis of the user operation history stored in the user operation history storage unit 54.

In step S55, the operation storage execution control unit 53 determines whether or not the habituation score Sₙ corresponding to the operation n is larger than the habituation threshold Sₜₕ.

In a case where it is determined in step S55 that the habituation score Sₙ corresponding to the operation n is larger than the habituation threshold Sₜₕ, the operation n is regarded as an operation having a high degree of habituation, and the process proceeds to step S56.

In step S56, the operation storage execution control unit 53 performs observation context-dependent operation determination processing, determines whether or not the operation n is an operation that depends on an observation context, and sets the context information I_{c} and the context dialog flag f_{c} when the operation n is an operation that depends on an observation context.

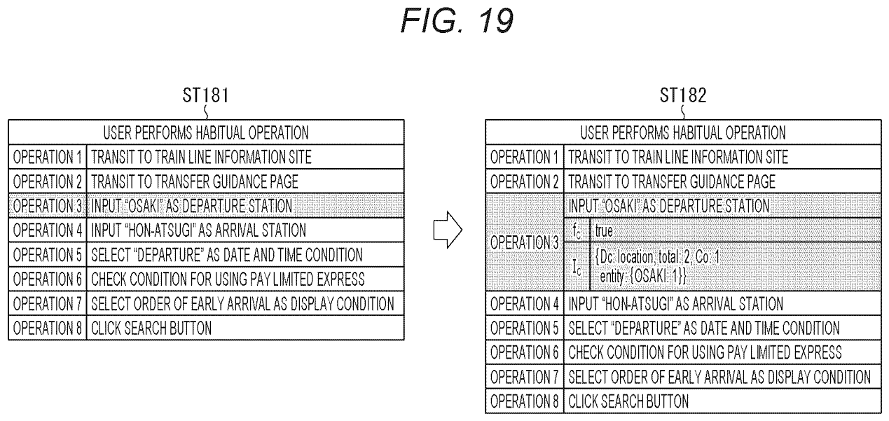

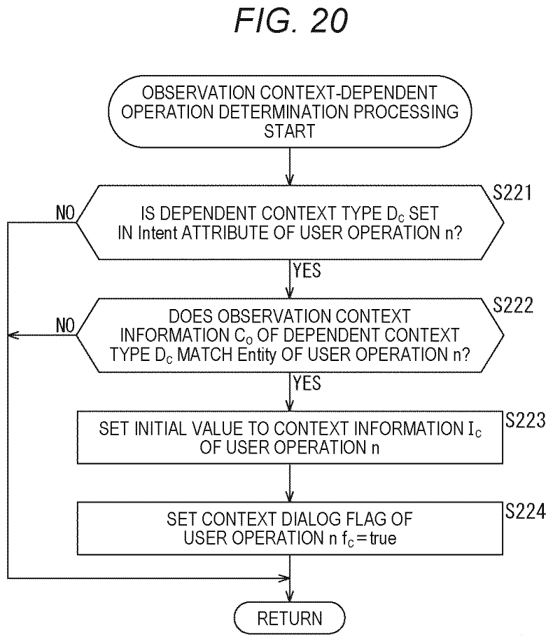

Note that the observation context-dependent operation determination processing will be described later in detail with reference to FIGS. 19 and 20.

In step S57, the operation storage execution control unit 53 determines whether or not the habituation score Sₙ₋₁ of the operation n−1 immediately preceding the operation n is smaller than the habituation threshold Sₜₕ.

In step S57, in a case where the habituation score Sₙ₋₁ of the operation n−1 immediately preceding the operation n is smaller than the habituation threshold Sₜₕ, the process proceeds to step S58.

In step S58, the operation storage execution control unit 53 adds the operation n−1 to the dialog cluster candidate.

In step S59, the operation storage execution control unit 53 adds the operation n to the dialog cluster candidate.

In step S60, the operation storage execution control unit 53 determines whether or not an instruction to end the process is given, and in a case where the instruction to end the process is given, the process ends.

Furthermore, in a case where the instruction to end is not given in step S60, the process proceeds to step S61.

In step S61, the operation storage execution control unit 53 increments the counter n by 1, and the process returns to step S52.

That is, when the number of operations n having the habituation score Sₙ higher than the habituation threshold Sₜₕ is plural (repeated) until an instruction for the end of the dialog clustering processing is given, the processing of steps S52 to S61 are repeated, the counter n is sequentially incremented by 1, and the operation of the dialog cluster candidate is continuously added.

Furthermore, since the first operation of the operation constituting the dialog cluster is the operation immediately preceding the operation having the habituation score Sₙ higher than the habituation threshold Sₜₕ, when the habituation score Sₙ₋₁ of the operation n−1 immediately preceding the operation n is lower than the habituation threshold Sₜₕ by the processing of step S57, the operation n−1 immediately preceding the operation n is included as the first operation of the dialog cluster candidate by the processing of step S58.

Accordingly, among the operations constituting the dialog cluster candidates, the habituation score Sₙ is larger than the habituation threshold Sₜₕ for operations other than the first operation, and thus, in step S57, the habituation score Sₙ is not smaller than the habituation threshold Sₜₕ. Therefore, the processing of step S58 is skipped.

Moreover, in a case where it is determined in step S55 that the habituation score Sₙ corresponding to the operation n is not larger than the habituation threshold Sₜₕ, the operation n is regarded as not an operation having a high degree of habituation, and the process proceeds to step S62.

In step S62, the operation storage execution control unit 53 performs determination processing for an operation having the same Intent and a different Entity, determines whether or not the operation n is an operation having the same Intent and a different Entity, and sets the selection dialog flag fₛ and the option information Iₛ when it is an operation having the same Intent and a different Entity.

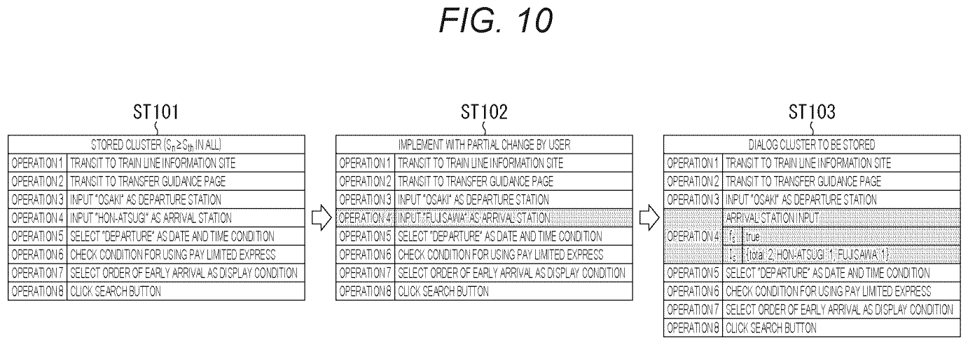

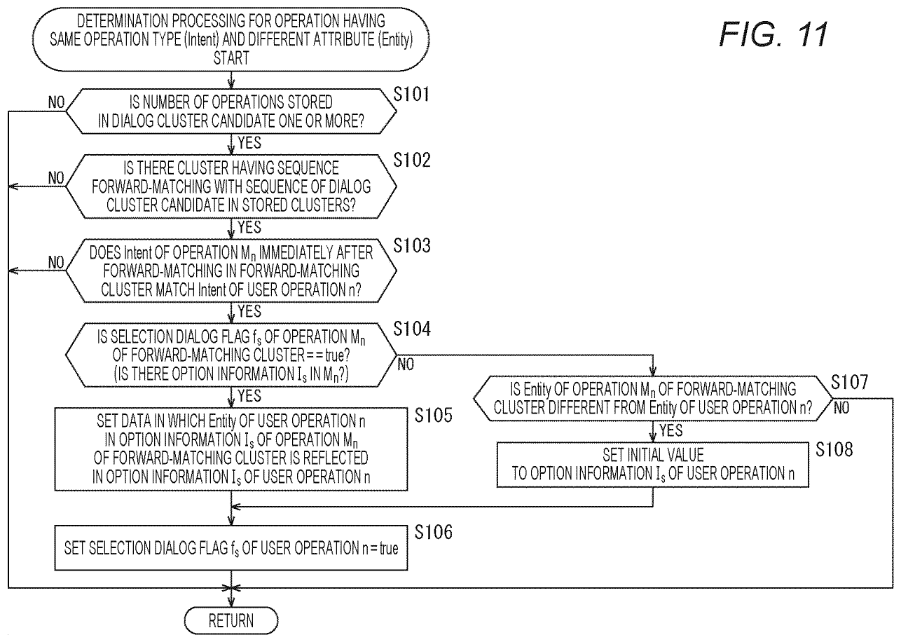

Note that the determination processing for an operation having the same Intent and a different Entity will be described later in detail with reference to FIGS. 10 and 11.

In step S63, the operation storage execution control unit 53 determines whether or not the selection dialog flag fₛ of the operation n is set to true.

In a case where it is determined in step S63 that the selection dialog flag fₛ of the operation n is set to true, the process proceeds to step S59.

Furthermore, in a case where it is determined in step S63 that the selection dialog flag fₛ of the operation n is not set to true, the process proceeds to step S64.

In step S64, the operation storage execution control unit 53 performs added and deleted operation determination processing, determines whether or not the operation n is either an added operation or a deleted operation, sets a confirmation dialog flag fₐ and confirmation information Iₐ when the operation n is either an added operation or a deleted operation, and further sets a dummy dialog flag f_{d} as necessary.

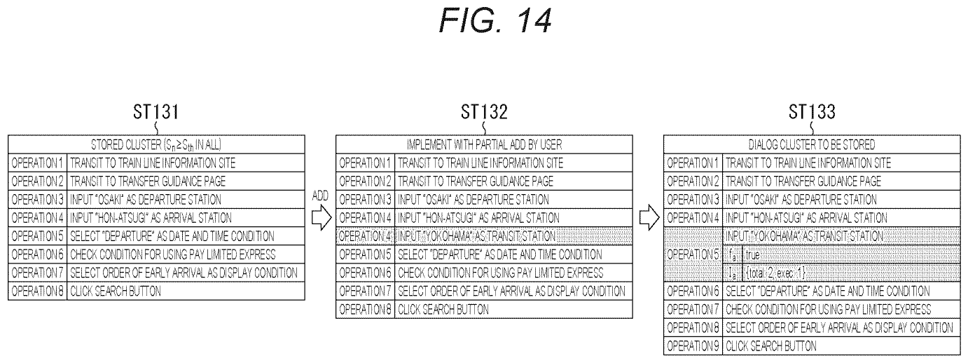

Note that the added and deleted operation determination processing will be described later in detail with reference to FIGS. 14 to 16.

In step S65, the operation storage execution control unit 53 determines whether or not the confirmation dialog flag fₐ of the operation n is set to true.

In a case where it is determined in step S65 that the confirmation dialog flag fₐ of the operation n is set to true, the process proceeds to step S59.

Furthermore, in a case where it is determined in step S65 that the confirmation dialog flag fₐ of the operation n is not set to true, the process proceeds to step S66.

In step S66, the operation storage execution control unit 53 determines whether or not the dummy dialog flag f_{d} of the operation n is set to true.

In a case where it is determined in step S66 that the dummy dialog flag f_{d} of the operation n is set to true, the process proceeds to step S59.

Furthermore, in a case where it is determined in step S66 that the dummy dialog flag f d of the operation n is not set to true, the process proceeds to step S67.

In step S67, the operation storage execution control unit 53 determines whether or not a habituation score Sₙ₋₁ of the previous operation n−1 is larger than the habituation threshold Sₜₕ, or whether or not any one of the selection dialog flag fₛ, the confirmation dialog flag fₐ, the context dialog flag f_{c}, and the dummy dialog flag f_{d} is true.

In step S67, in a case where it is regarded that the habituation score Sₙ₋₁ of the operation n−1 is larger than the habituation threshold Sₜₕ, or that any one of the selection dialog flag fₛ, the confirmation dialog flag fₐ, the context dialog flag f_{c}, and the dummy dialog flag f_{d} is true, the operations up to the immediately preceding operation are regarded as a part of the operation included in the dialog cluster candidate, and the process proceeds to step S68.

Note that, in step S67, in a case where it is regarded that the habituation score Sₙ₋₁ of the operation n−1 is not larger than the habituation threshold Sₜₕ, and that any one of the selection dialog flag fₛ, the confirmation dialog flag fₐ, the context dialog flag f_{c}, and the dummy dialog flag f_{d} is not true, the immediately preceding operation is regarded as an operation not included in the dialog cluster candidate, and the process proceeds to step S60.

In step S68, the operation storage execution control unit 53 determines whether or not the operation included in the dialog cluster candidate configured by the operations up to the immediately preceding operation is two or less.

Since it is assumed that the dialog cluster is three or more, in a case where the number of operations included in the dialog cluster candidate configured by the operations up to the immediately preceding operation is two or less in step S68, it is considered that the dialog cluster is not configured, and the process proceeds to step S69.

Then, in step S69, the operation storage execution control unit 53 clears the information on the operation stored as the dialog cluster candidate, and the process proceeds to step S60.

Furthermore, in a case where the number of operations included in the dialog cluster candidate configured by the operations up to the immediately preceding operation is not two or less in step S68, since it is considered that the dialog cluster candidate includes three or more operations, the process proceeds to step S70.

In step S70, the operation storage execution control unit 53 determines whether or not the dialog cluster candidate stored in the habituation operation/dialog cluster storage unit 55 includes an operation in which any of the selection dialog flag fₛ, the confirmation dialog flag fₐ, the context dialog flag f_{c}, and the dummy dialog flag f_{d} is set to true.

In step S70, in a case where the dialog cluster candidate stored in the habituation operation/dialog cluster storage unit 55 does not include an operation in which any of the selection dialog flag fₛ, the confirmation dialog flag fₐ, the context dialog flag f_{c}, and the dummy dialog flag f_{d} is set to true, the process proceeds to step S69.

That is, in this case, since it is not necessary to perform registration as the dialog cluster, the stored information on the dialog cluster candidate is cleared.

Furthermore, in step S70, in a case where it is determined that the dialog cluster candidate stored in the habituation operation/dialog cluster storage unit 55 includes an operation in which any of the selection dialog flag fₛ, the confirmation dialog flag fₐ, the context dialog flag f_{c}, and the dummy dialog flag f_{d} is set to true, the process proceeds to step S71.

In step S71, the operation storage execution control unit 53 determines whether or not there is the completely same cluster having the same operation as the operation included in the habituation operation cluster candidate currently being processed and the sequence is the same (the order of the sequence is the same) as that of the dialog cluster candidate currently being processed, among clusters (hereinafter, simple referred to as registered cluster) of both the already-registered habituation operation clusters and the dialog cluster stored in the habituation operation/dialog cluster storage unit 55.

That is, in a case where the dialog cluster candidate is completely the same as the cluster already registered in the habituation operation/dialog cluster storage unit 55, it is necessary to update the context information I_{c}. Therefore, it is determined whether or not there is completely the same cluster.

In step S71, in a case where there is the completely same cluster as the dialog cluster candidate currently being processed in the already-registered clusters stored in the habituation operation/dialog cluster storage unit 55, the process proceeds to step S72.

In step S72, the operation storage execution control unit 53 performs the context information update processing of the dialog cluster candidate and updates the context information I_{c} of the dialog cluster candidate.

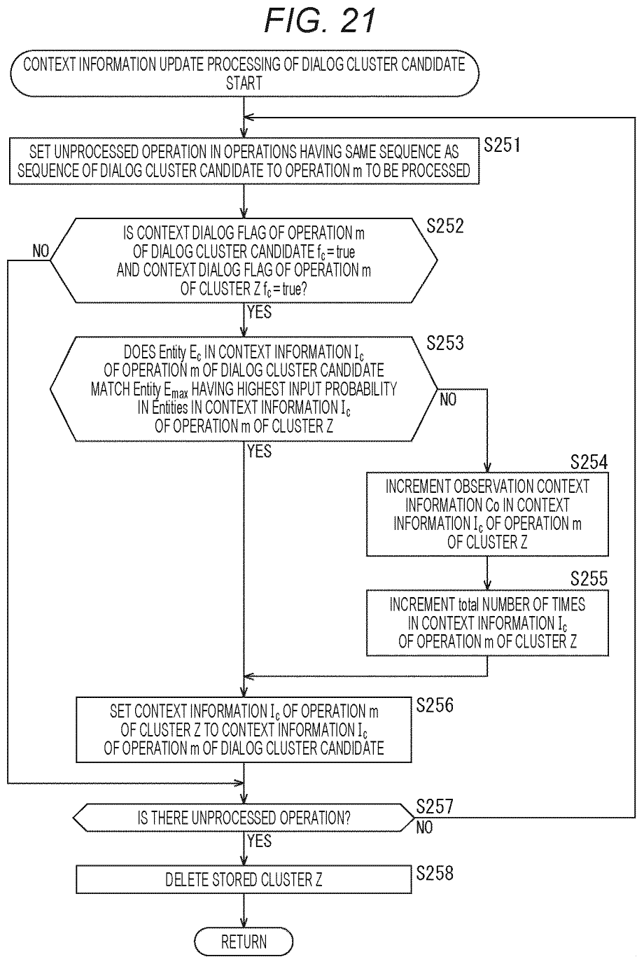

Note that the context information update processing of the dialog cluster candidate will be described later in detail with reference to FIG. 21.

Furthermore, in step S71, in a case where the already-registered clusters stored in the habituation operation/dialog cluster storage unit 55 does not include the completely same cluster as the dialog cluster candidate current being processed, the processing of step S72 is skipped and the process proceeds to step S73.

In step S73, the operation storage execution control unit 53 determines whether or not there is a cluster included in a sequence of the dialog cluster candidate currently being processed, among the already-registered clusters stored in the habituation operation/dialog cluster storage unit 55.

In step S73, in a case where it is determined that there is a cluster included in a sequence of the dialog cluster candidate currently being processed in the already-registered clusters stored in the habituation operation/dialog cluster storage unit 55, the process proceeds to step S74.

In step S74, the operation storage execution control unit 53 deletes the registered cluster included in a sequence of the dialog cluster candidate currently being processed, among the already-registered clusters stored in the habituation operation/dialog cluster storage unit 55.

Furthermore, in step S73, in a case where it is determined that there is no cluster included in a sequence of the dialog cluster candidate currently being processed in the already-registered clusters stored in the habituation operation/dialog cluster storage unit 55, the processing of step S74 is skipped, and the process proceeds to step S75.

In step S75, the operation storage execution control unit 53 determines whether or not there is a cluster that can be replaced with the dialog cluster currently being processed, among the already-registered clusters stored in the habituation operation/dialog cluster storage unit 55.

In step S75, in a case where it is determined that there is a cluster that can be replaced with the dialog cluster currently being processed in the already-registered clusters stored in the habituation operation/dialog cluster storage unit 55, the process proceeds to step S76.

In step S76, the operation storage execution control unit 53 deletes the registered cluster that can be replaced with the dialog of the dialog cluster candidate currently being processed, among the already-registered dialog clusters stored in the habituation operation/dialog cluster storage unit 55.

Furthermore, in step S75, in a case where it is determined that there is no cluster that can be replaced with the dialog cluster currently being processed in the already-registered clusters stored in the habituation operation/dialog cluster storage unit 55, the processing of step S76 is skipped, and the process proceeds to step S77.

In step S77, the operation storage execution control unit 53 registers the operation of the dialog cluster candidate currently being processed in the habituation operation/dialog cluster storage unit 55 as a new dialog operation cluster.

That is, among the already-registered clusters stored in the habituation operation/dialog cluster storage unit 55, for the cluster having the same sequence as the operation included in the dialog cluster candidate currently being processed, the context information is updated. For the cluster including the operation included in the dialog cluster candidate currently being processed or the cluster that can be replaced is deleted. For the other dialog cluster candidates currently being processed are regarded as a dialog cluster including a plurality of new operations, and are registered in the habituation operation/dialog cluster storage unit 55.

When a new operation n is received by the above processing, the habituation score Sₙ is sequentially obtained and compared with the habituation threshold Sₜₕ so that the dialog cluster candidate is set.

Furthermore, by comparing the operation constituting the dialog cluster candidate with the operation constituting the already-registered clusters, a dialog cluster candidate including an operation completely different from that of the already-registered clusters is registered as a new dialog cluster.

As a result, it is possible to sequentially register, as a dialog cluster, a dialog cluster candidate including a plurality of operations having a high habituation score and a high degree of habituation as the operation of the user, in which the dialog flag is set to true.

Note that, since there is a possibility that the habituation deviates from the registered dialog cluster with the lapse of time, it may be set such that the dialog cluster registered for a predetermined period or more is deleted.

<Operation Having Same Operation Type (Intent) and Different Attribute (Entity)>

Next, with reference to FIG. 10, an operation having the same operation type (Intent) and a different attribute (Entity) will be described. Note that, hereinafter, the operation type and the attribute are also simply referred to as Intent and Entity, respectively.

A case where, for example, a habituation operation cluster including operations 1 to 8 illustrated in a state ST101 illustrated in the left part of FIG. 10 is generated and performed by the above-described habituation operation clustering processing will be considered.

In the state ST101, it is assumed that the operation 1 is an operation of transitioning to a route information site, the operation 2 is an operation of transitioning to a transfer guidance page, the operation 3 is an operation of inputting “Osaki” as a departure station, the operation 4 is an operation of inputting “Hon-Atsugi” as an arrival station, the operation 5 is an operation of selecting “Departure” as a date and time condition, the operation 6 is an operation of checking a condition for using a pay limited express, the operation 7 is an operation of selecting an arrival order as a display condition, and the operation 8 is an operation of clicking a search button.

Here, it is assumed that, in a case where the habituation operation cluster including the operations 1 to 8 indicated by the state ST101 in the left part of FIG. 10 are collectively performed, for example, as indicated by a state ST102 in the center part of FIG. 10, an operation 4′ is performed instead of the operation 4, and an operation of inputting “Fujisawa” instead of “Hon-Atsugi” as an arrival station is performed.

In such a case, in the case of only the habituation operation clustering processing, the clusters of operations 1 to 3 and the clusters of operations 5 to 8 are individually registered as the habituation operation cluster. That is, the habituation operation cluster in the state ST101 is substantially divided and registered, and cannot be collectively performed.

Here, the operation 4 and the operation 4′ have the same Intent (operation type) of “Arrival station input”, and since station names of arrival stations are “Hon-Atsugi” and “Fujisawa”, they have different Entities (attributes).

Therefore, as indicated by a state ST103 in the right part of FIG. 10, the operation storage execution control unit 53 sets the selection dialog flag fₛ and the option information Iₛ after setting “arrival station input” which is the same intent for the operation 4.

The selection dialog flag fₛ is, for example, a flag that sets whether or not to implement processing of presenting options of operations to the user through a dialog and allowing the user to select an operation in a case where an operation having the same Intent and a different Entity among the operations collectively operated set by the habituation operation cluster is performed.

More specifically, the selection dialog flag fₛ is set to true when the processing of presenting options of operations through a dialog and allowing the user to select an operation is implemented, and is set to false otherwise.

For example, when an operation having the same Intent and a different entity is performed on the habituation operation cluster indicated by the state ST101 in FIG. 10, as indicated by the state ST102, the selection dialog flag fₛ as indicated by the operation 4′ instead of the operation 4 is set as indicated by the operation 4 in the state ST103 in FIG. 10.

Here, when the selection dialog flag fₛ is set to true, the option information Iₛ is information of options to be specifically presented to the user, and information on the number of times each of the options has been selected and the total number of times the options have been selected is registered.

More specifically, the state ST103 in FIG. 10 illustrates a state in which “Total: 2, Hon-Atsugi: 1, Fujisawa: 1” is registered as the option information Is with the initial value, and illustrates that Hon-Atsugi and Fujisawa are selected as options once each, that is, two times in total. Note that the total number of times is set to 2 as an initial value.

In the case of the state ST103 in FIG. 10, Hon-Atsugi and Fujisawa are set as options. However, when presented as options, the respective input probabilities are calculated and presented in descending order of the input probabilities, and when the input probabilities are the same, the options are presented from the most recently selected options. Here, the input probability is obtained by dividing the number of times the options have been selected by the total number of times, and in the case of the state ST103 in FIG. 10, the input probability of each of the options, Hon-Atsugi and Fujisawa, is 0.5 (=1/2).

<Determination Processing for Operation Having Same Intent and Different Entity>

Next, with reference to FIG. 11, the determination processing for an operation having the same Intent and a different Entity will be described. Note that the determination processing for an operation having the same Intent and a different entity in the flowchart of FIG. 11 is the processing of step S62 in the flowchart of FIG. 9.

In step S101, the operation storage execution control unit 53 determines whether or not the number of operations stored in the dialog cluster candidate is one or more.

In a case where it is determined in step S101 that the number of operations stored in the dialog cluster candidate is one or more, the process proceeds to step S102.

In step S102, the operation storage execution control unit 53 determines whether or not there is a stored cluster whose sequence matches with that of the dialog cluster candidate in the clusters stored in the habituation operation/dialog cluster storage unit 55.

In step S102, in a case where it is determined that there is a stored cluster whose sequence matches with the sequence of the dialog cluster candidate in the dialog clusters stored in the habituation operation/dialog cluster storage unit 55, the process proceeds to step S103.

In step S103, the operation storage execution control unit 53 determines whether or not the Intent of the operation Mₙ immediately after the matching of the stored cluster matches the Intent of the operation n, the stored cluster having a sequence forward-matching with the sequence of the dialog cluster candidate.

In step S103, in a case where the Intent of the operation Mₙ immediately after the matching of the stored cluster having a sequence forward-matching with the sequence of the dialog cluster candidate matches the Intent of the operation n, the process proceeds to step S104.

In step S104, the operation storage execution control unit 53 determines whether or not the selection dialog flag fₛ is set to the operation Mₙ and the selection dialog flag fₛ is set to true, that is, whether or not the option information Iₛ is set.

In a case where it is regarded in step S104 that the selection dialog flag fₛ is set to true and that the option information Iₛ is set, the process proceeds to step S105.

In step S105, the operation storage execution control unit 53 sets, as the “option information Iₛ” of the operation n, data in which Entity information on the operation n is reflected in the option information Iₛ of the operation Mₙ of the forward-matching stored cluster.

In step S106, the operation storage execution control unit 53 sets the selection dialog flag fₛ to the operation n, and further sets the selection dialog flag fₛ to true.

Furthermore, in a case where it is regarded in step S104 that the selection dialog flag fₛ is not set or that the selection dialog flag fₛ is set to false and the option information Iₛ is not set, the process proceeds to step S107.

In step S107, the operation storage execution control unit 53 determines whether or not the Entity of the operation Mₙ immediately after the matching of the dialog cluster matches the Entity of the operation n, the dialog cluster having a sequence forward-matching with the sequence of the dialog cluster candidate.

In step S107, in a case where the Entity of the operation Mₙ immediately after the matching of the dialog cluster having a sequence forward-matching with the sequence of the dialog cluster candidate is different from the Entity of the operation n, the process proceeds to step S108.

In step S108, the operation storage execution control unit 53 sets 1 as an initial value of the number of times of selection of the option information Is of the operation n.

Furthermore, in a case where it is determined in step S101 that the number of operations stored in the dialog cluster candidate is not one or more, in a case where it is determined in step S102 that there is no dialog cluster having a sequence forward-matching with the sequence of the dialog cluster candidate in the clusters stored in the habituation operation/dialog cluster storage unit 55, in a case where the Intent of the operation Mₙ immediately after matching of the stored cluster having a sequence forward-matching with the sequence of the dialog cluster candidate does not match the Intent of the operation n in step S103, or in a case where the Entity of the operation Mₙ immediately after matching of the stored cluster having a sequence forward-matching with the sequence of the dialog cluster candidate is the same as the Entity of the operation n in step S107, the process ends.

By the above processing, it is determined whether or not the operation n of the user is an operation having the same Intent and a different Entity, and in a case where the Intent is the same and the Entity is different, the selection dialog flag fₛ is set to true at the first time, and the option information Iₛ is set with the initial value, and thereafter, the option information Is according to the new operation n is sequentially set.

<Case of Dialog Generation for Operation Having the Same Intent and Different Entity>

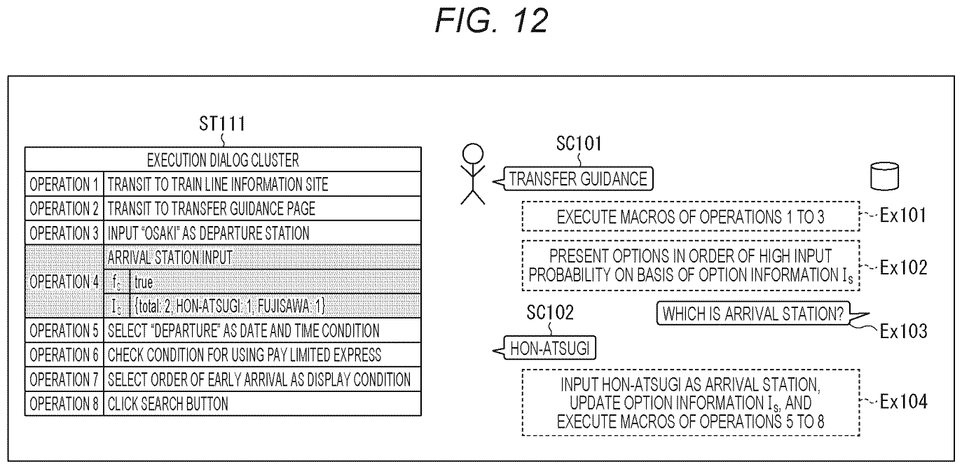

Next, with reference to FIG. 12, a case of dialog generation for an operation having the same Intent and a different Entity will be described.

For example, consider a case where a dialog cluster as illustrated in a state ST111 as illustrated in FIG. 12 is set. Note that the dialog cluster in the state ST111 is the same as the dialog cluster in the state ST103 in FIG. 10.

In the operation 4 in the left part of FIG. 12, since the selection dialog flag fₛ is set to true, a state is set in which the processing of generating the dialog by the dialog cluster is performed.

Here, for example, as illustrated in the right part of FIG. 12, when the user 11 utters “Transfer guidance” or the like in the processing SC101, the operation storage execution control unit 53 recognizes that an instruction to perform the dialog cluster illustrated in the left part of FIG. 12 related to the transfer guidance has been made.

In processing Ex101, the operation storage execution control unit 53 performs the operations 1 to 3 indicated by the state ST111 in FIG. 12 in response to the utterance “Transfer guidance”.

In processing Ex102, the operation storage execution control unit 53 performs the processing of the operation 4 and since the selection dialog flag fₛ is set to true, the options are presented in descending order of the input probability according to the option information Iₛ. Here, since both Hon-Atsugi and Fujisawa have an input probability of 0.5, for example, the latest input result may be regarded as an option with a high input probability and presented.

In processing Ex103, the operation storage execution control unit 53 outputs a speech prompting the selection from the presented options such as “Which is the arrival place?”.

Here, in processing SC102, when the user utters “Hon-Atsugi” or the like, the operation storage execution control unit 53 recognizes that “Hon-Atsugi” has been selected as an option.

In process Ex104, the operation storage execution control unit 53 inputs Hon-Atsugi to the arrival station to update the option information Iₛ, and performs the operations 5 to 8 in the state ST111.

By such a series of processing, when a change occurs in the habituation operation and an operation having the same Intent and a different Entity is performed, an inquiry dialog with Entity as an option is presented, and processing according to the selection result is performed.

As a result, even if a change occurs in the habituation operation, a dialog cluster is set for the habituation operation cluster, and a flexible response is possible.

<Dialog Processing for Operation Having the Same Intent and Different Entity>

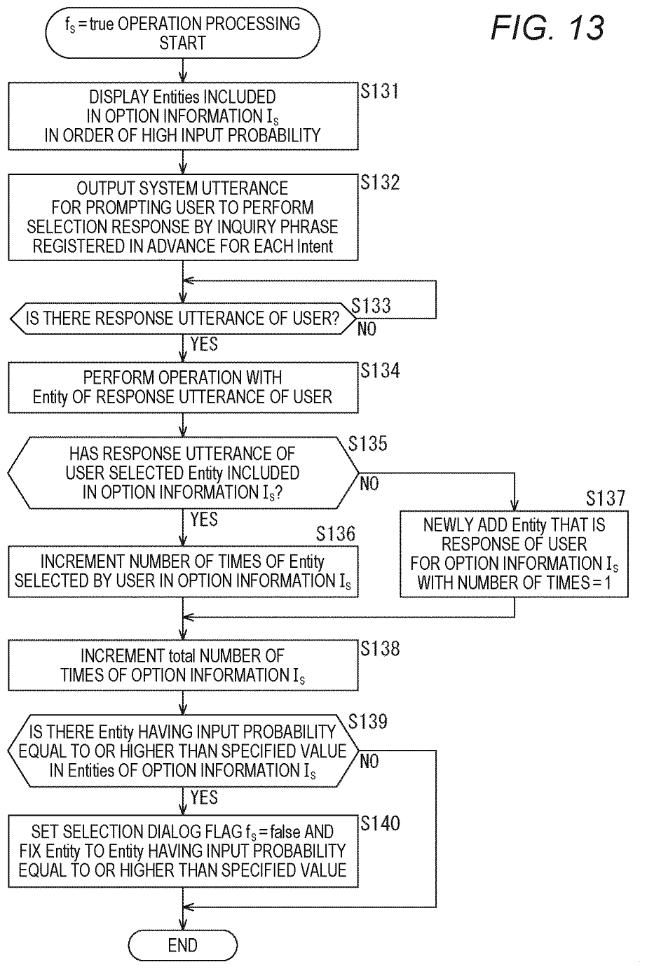

Next, with reference to FIG. 13, the dialog processing for an operation having the same Intent and a different Entity will be described.

Note that this processing is performed when an operation having the same Intent and a different Entity in which the selection dialog flag fₛ is set to true is performed. That is, the processing is performed when the processing of the operation 4 in the state ST111 of FIG. 12 is performed.

In step S131, the operation storage execution control unit 53 displays (presents) the Entities included in the option information Is as options in descending order of input probability. In the case of FIG. 12, Hon-Atsugi and the Fujisawa are presented as options, but since the input probabilities are the same, for example, the most recently input option may be presented first as an option with a high input probability.

In step S132, the operation storage execution control unit 53 outputs a system utterance prompting the user to select (respond) an option on the basis of an inquiry phrase registered in advance for each Intent.

More specifically, the operation storage execution control unit 53 controls the response generation unit 63 to generate a system utterance prompting the user to select (respond) an option on the basis of an inquiry phrase registered in advance for each Intent, and causes the speech synthesis processing unit 65 to output the system utterance as data. The speech synthesis processing unit 65 performs speech synthesis processing on the data of the system utterance and causes the speech output unit 67 to output the data as speech.

Note that, since the processing related to the speech output of the system utterance is similar, the description thereof will be omitted below.

In step S133, the operation storage execution control unit 53 determines whether or not there has been a response utterance that is a selection result of the user for the options, and repeats similar processing until it is determined that there has been a response utterance.

More specifically, the operation storage execution control unit 53 determines whether or not there has been a response utterance on the basis of the user's utterance phrase that has been subjected to speech recognition processing by the speech recognition processing unit 57 for a speech signal corresponding to the user utterance input via the speech input unit 56 and converted into text, and repeats similar processing until it is determined that there has been a response utterance.

Note that, since the processing related to the speech of the user is similar, the description thereof will be omitted below.

Then, in a case where it is regarded in step S133 that there is a response utterance that is a selection result of the user for the options, the process proceeds to step S134.

In step S134, the operation storage execution control unit 53 performs the operation (operation 4) with the Entity of the option corresponding to the response utterance.

In step S135, the operation storage execution control unit 53 determines whether or not the user's response utterance is an Entity included in the option information Iₛ.

In a case where it is determined in step S135 that the user's response utterance is an Entity included in the option information Iₛ, the process proceeds to step S136.

In step S136, the operation storage execution control unit 53 increments the number of times of the Entity selected by the response utterance included in the option information Iₛ by 1.

On the other hand, in a case where it is determined in step S135 that the user's response utterance is an Entity not included in the option information Iₛ, the process proceeds to step S137.

In step S137, the operation storage execution control unit 53 newly adds and registers an Entity newly selected by the response utterance in the option information Iₛ, and sets the number of times to 1 which is the initial value.

In step S138, the operation storage execution control unit 53 increments the information of the total number of times in the option information Iₛ by 1.

In step S139, the operation storage execution control unit 53 determines whether or not there is an Entity having an input probability of equal to or higher than a specified value among Entities in the option information Iₛ.

In step S139, in a case where there is an Entity whose input probability is equal to or higher than the specified value among the Entities in the option information Iₛ, the process proceeds to step S140.

In step S140, the operation storage execution control unit 53 sets the selection dialog flag fₛ to false and sets an operation in which the Entity is fixed to an Entity having the input probability of equal to or higher than a specified value, and the process ends.

In step S139, in a case where there is no Entity whose input probability is equal to or higher than the specified value among the Entities in the option information Iₛ, the processing of step S140 is skipped and the process ends.

Through the series of processing described above, for the operation in which the selection dialog flag fₛ is set to true, the Entity in the option information Iₛ is presented as an option in the order of the input probability to prompt the selection, and the processing is performed with the selected Entity.

Then, for the selected Entity, the number of times is incremented by 1, and the total number of times is incremented by 1. At this time, in a case where a new Entity other than the Entity presented as an option is selected, the Entity is newly registered as an option and the number of times is set to 1.

Moreover, in a case where the input probability of the Entity is sequentially calculated and becomes equal to or higher than the specified value, on the assumption that the option in which the input probability is equal to or higher than the specified value is always selected as the Entity by the user, the selection dialog flag fₛ is set to false, and the operation fixed to the Entity having the input probability of being always selected of equal to or higher than the specified value is set to be performed.

That is, in a case where an operation in which the Entity is the fixed is set as described above, thereafter, a normal habituation operation cluster in which no dialog is performed functions, and a plurality of operations corresponding to a change in the habituation operation is collectively performed.

As a result, even when a change occurs in the habituation operation, a dialog cluster is set, and dialog processing is performed to prompt selection of an option, and moreover, a predetermined Entity is repeatedly selected on the basis of the input probability, and an operation in which the Entity is fixed to a predetermined Entity is performed when the value becomes equal to or higher than a specified value, so that a flexible response is possible.

<Added and Deleted Operation>

(Added Operation)

Next, an added operation will be described with reference to FIG. 14.

A case where, for example, a habituation operation cluster including operations 1 to 8 illustrated in a state ST131 illustrated in the left part of FIG. 14 is generated and performed by the above-described habituation operation clustering processing will be considered. Note that the state ST131 is the same as the state ST101 in FIG. 10.

Here, it is assumed that, in a case where the habituation operation cluster including the operations 1 to 8 indicated by the state ST131 in the left part of FIG. 14 are collectively performed, for example, as indicated by a state ST132 in the center part of FIG. 14, an operation 4′ is performed between the operation 4 and the operation 5, and an operation of inputting “Yokohama” as a transit point is performed.

In such a case, in a case of only the habituation operation clustering processing, when both of the operation 4′ and the operation 5 have the habituation score Sₙ smaller than the habituation threshold Sₜₕ and the time interval Tₙ shorter than the threshold Iₜₕ, the operation 4′ and the operation 5 are regarded as a dialog cluster, and, as indicated by a state ST133 in the right part of FIG. 14, the operation storage execution control unit 53 sets the operation 4′ to the operation 5, increments the subsequent operation by 1, further sets the operation 5 to “input “Yokohama” to the transit station”, and then sets the confirmation dialog flag f a and the confirmation information Iₐ.

The confirmation dialog flag fₐ is, for example, a flag for setting whether or not to select execution of the operation added by the dialog for the user in a case where the adding operation to the operation to be collectively performed set by the habituation operation cluster is performed.

More specifically, the confirmation dialog flag f a is set to true in a case of presenting the addition operation by a dialog and inquiring the user whether or not the added operation is performed, and the confirmation dialog flag fₐ is set to false otherwise.

For example, when an operation indicated by the operation 4′ is performed between the operations 4 and 5 as indicated by the state ST132 on the habituation operation cluster indicated by state ST131 in FIG. 14, the selection dialog flag fₐ is set for the operation 5 instead of the operation 4′.

When the confirmation dialog flag fₐ is set to true, the confirmation information Iₐ is specifically information for calculating the input probability of the user, and information of the number of times of instruction for execution and the total number of times is registered. Note that the total number of times is set such that the initial value is 2 and the execution probability is 0.5 also in the initial setting.

More specifically, FIG. 14 illustrates that “Total: 2, exec: 1” is registered as the confirmation information Iₐ, the total number of times of confirmation is 2, and the execution instruction is selected once.

That is, in the case of FIG. 14, the execution probability that an instruction for execution is given is calculated as 0.5.

(Deleted Operation)

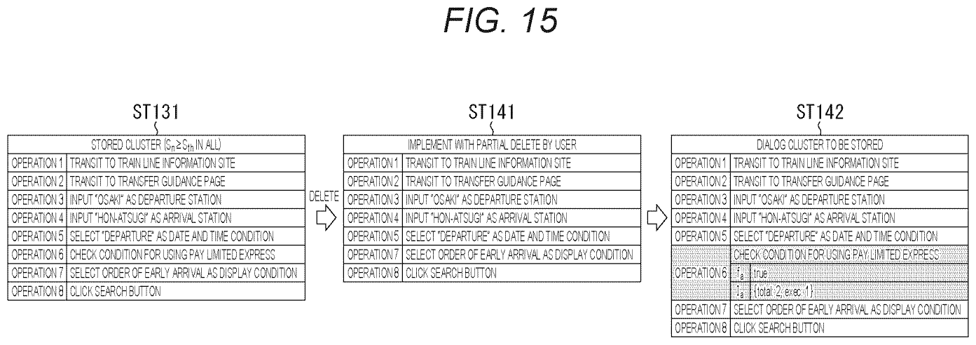

Next, a deleted operation will be described with reference to FIG. 15.

Here, it is assumed that, in a case where the habituation operation cluster including the operations 1 to 8 indicated by the state ST131 (the same as that in FIG. 14) in the left part of FIG. 15 is collectively performed, for example, as indicated by the state ST141 in the center part of FIG. 15, the operation of “checking a condition for using a pay limited express” which is the operation 6 is deleted.

In such a case, in a case of only the habituation operation clustering processing, when the operation 6 has the habituation score Sₙ smaller than the habituation threshold Sₜₕ and the time interval Tₙ shorter than the threshold Iₜₕ, the operation 6 is regarded as a dialog cluster, and, as indicated by a state ST142 in the right part of FIG. 15, the operation storage execution control unit 53 sets to “checking a condition for using a pay limited express”, and then sets the confirmation dialog flag fₐ and the confirmation information Iₐ.

For example, when the operation 6 is deleted from the habituation operation cluster indicated by the state ST131 in FIG. 15 as indicated by the state ST141, the operation storage execution control unit 53 sets the confirmation dialog flag fₐ for the operation 6 as indicated by the state ST142 in FIG. 15.

Furthermore, in the state ST142 of FIG. 15 indicates that “Total: 2, exec: 1” is registered as the confirmation information Iₐ, the total number of times of confirmation is 2, and the execution instruction is selected once.

That is, in the case of the state ST142 of FIG. 15, the execution probability that the instruction for execution is given is calculated as 0.5.

<Added and Deleted Operation Determination Processing>

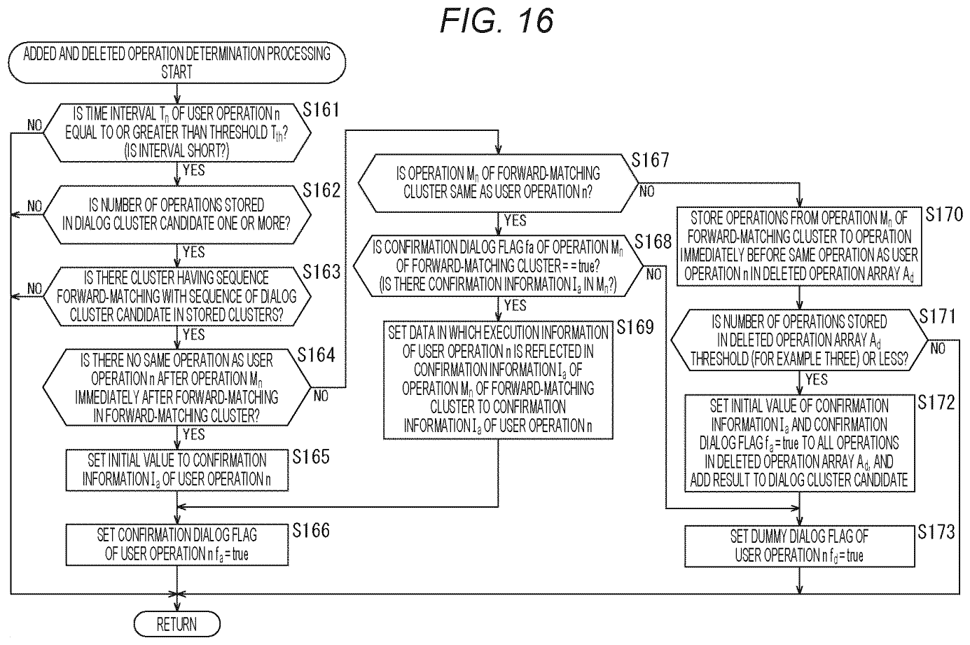

Next, the added and deleted operation determination processing will be described with reference to the flowchart of FIG. 16. Note that the added and deleted operation determination processing in the flowchart of FIG. 16 is the processing of step S64 in the flowchart of FIG. 9.

In step S161, the operation storage execution control unit 53 determines whether or not the time interval Tₙ of the operation n is equal to or greater than a predetermined threshold Tₜₕ, that is, whether or not the time interval is shorter than the threshold.

In a case where the time interval Tₙ of the operation n is equal to or greater than the predetermined threshold Tₜₕ in step S161, the process proceeds to step S162.

In step S162, the operation storage execution control unit 53 determines whether or not the number of operations stored in the dialog cluster candidate is one or more.

In a case where it is determined in step S162 that the number of operations stored in the dialog cluster candidate is one or more, the process proceeds to step S163.

In step S163, the operation storage execution control unit 53 determines whether or not there is a stored cluster whose sequence matches with that of the dialog cluster candidate in the clusters stored in the habituation operation/dialog cluster storage unit 55.

In step S163, in a case where it is determined that there is a stored cluster whose sequence matches with the sequence of the dialog cluster candidate in the clusters stored in the habituation operation/dialog cluster storage unit 55, the process proceeds to step S164.

In step S164, the operation storage execution control unit 53 determines whether or not there is no operation same as the operation n after the operation Mₙ immediately after the matching of the stored cluster having the sequence forward-matching with the sequence of the dialog cluster candidate, that is, whether or not the operation n is an added operation.

In step S164, in a case where it is determined that there is no operation same as the operation n after the operation Mₙ immediately after the matching of the stored cluster having the sequence forward-matching with the sequence of the dialog cluster candidate, that is, the operation n is an added operation, the process proceeds to step S165.

In step S165, the operation storage execution control unit 53 sets the confirmation information Iₐ and sets an initial value for the operation n.

In step S166, the operation storage execution control unit 53 sets the confirmation dialog flag fₐ to the operation n, and further sets the confirmation dialog flag fₐ to true.

Furthermore, in step S164, in a case where it is determined that there is an operation same as the operation n after the operation Mₙ immediately after the matching of the stored cluster having the sequence forward-matching with the sequence of the dialog cluster candidate, that is, the operation n is not an added operation, the process proceeds to step S167.

In step S167, the operation storage execution control unit 53 determines whether or not the operation Mₙ immediately after the matching of the stored cluster having the sequence forward-matching with the sequence of the dialog cluster candidate is the same as the operation n, that is, whether or not the operation n is a deleted operation.

In step S167, in a case where it is regarded that the operation Mₙ immediately after the matching of the stored cluster having the sequence forward-matching with the sequence of the dialog cluster candidate is the same as the operation n, that is, the operation n is not a deleted operation, the process proceeds to step S168.

In step S168, the operation storage execution control unit 53 determines whether or not the confirmation dialog flag fₐ is set to the operation Mₙ and the confirmation dialog flag fₐ is set to true, that is, whether or not the confirmation information Iₐ is set.

In step S168, in a case where it is regarded that the confirmation dialog flag fₐ is set to the operation Mₙ and the confirmation dialog flag fₐ is set to true, that is, the confirmation information Iₐ is set, the process proceeds to step S169.

In step S169, the operation storage execution control unit 53 sets, as the confirmation information Iₐ of the operation n, data in which the execution information of the operation n is reflected in the confirmation information Iₐ of the operation Mₙ of the forward-matching stored cluster, and the process returns to step S166. That is, here, only the confirmation information Iₐ is updated.

On the other hand, in step S167, in a case where it is regarded that the operation Mₙ immediately after the matching of the stored cluster having the sequence forward-matching with the sequence of the dialog cluster candidate is not the same as the operation n, that is, the operation n is a deleted operation, the process proceeds to step S170.

In step S170, the operation storage execution control unit 53 stores, in the habituation operation/dialog cluster storage unit 55, the operations from the operation Mₙ to the operation immediately preceding the same operation as the operation n of the forward-matching stored cluster, as a deleted operation array A_{d}.

In step S171, the operation storage execution control unit 53 determines whether or not the number of operations stored as the deleted operation array A_{d} in the habituation operation/dialog cluster storage unit 55 is a predetermined threshold (for example, three) or less.

That is, in a case where the number of operations to be deleted is too large, it cannot be treated as the same habituation operation cluster, and thus a predetermined threshold is set for the number of operations stored as the deleted operation array A_{d}.

Note that the predetermined threshold set for the number of operations stored in the deleted operation array A_{d} may be enabled to be arbitrarily set.

In step S171, in a case where the number of operations stored as the deleted operation array A_{d} is a predetermined threshold (for example, three) or less, the process proceeds to step S172.

In step S172, the operation storage execution control unit 53 sets the initial value of the confirmation information Iₐ to all the operations stored as the deleted operation array A_{d}, sets the confirmation dialog flag fₐ to true, and causes the habituation operation/dialog cluster storage unit 55 to store the operations as a dialog cluster candidate.

In step S173, the operation storage execution control unit 53 sets the dummy dialog flag f_{d} and sets the dummy dialog flag f_{d} to true for the operation n. On the other hand, in step S168, in a case where it is regarded that the confirmation dialog flag fₐ of the operation Mₙ is set to false, that is, the confirmation information Iₐ is not set, the process proceeds to step S173.

Furthermore, in a case where the time interval Tₙ of the operation n is not equal to or greater than the predetermined threshold Tₜₕ in step S161, in a case where it is determined in step S162 that the number of operations stored in the dialog cluster candidate is not one or more, in a case where it is determined in step S163 that there is no stored cluster having a sequence forward-matching with the sequence of the dialog cluster candidate in the clusters stored in the habituation operation/dialog cluster storage unit 55, or in a case where the number of operations stored as the deleted operation array A_{d} is not the predetermined threshold (for example, 3) or less in step S171, the process ends.

Through the above processing, it is determined whether or not the operation n of the user is an added operation or a deleted operation. In a case where the operation n is an added operation or the deleted operation, the confirmation dialog flag fₐ is set to true, the confirmation information Iₐ is set with the initial value, and thereafter, the confirmation information Iₐ according to the new operation n is sequentially set.

Note that the dummy dialog flag f_{d} is a flag for adding an operation to be included in the dialog cluster candidate although the operation has the habituation score Sₙ lower than the threshold Sₜₕ to the dialog cluster candidate by making a transition from the processing of steps S62 to S66 in the dialog clustering processing described with reference to the flowchart of FIG. 9 to the processing of step S59.

That is, since the dummy dialog flag f_{d} is a dialog flag intended to be added to the dialog cluster candidate, no dialog is performed with the user even at the time of execution for the operation having the dummy dialog flag f_{d} of true.

For example, since the operation 5 in the state ST103 in FIG. 10 is immediately after the operation 4 having a different Entity, the number of transitions Fₙ and the transition probability Pₙ of the operation 5 are low, and thus the habituation score Sₙ is lower than the threshold Sₜₕ, but since it is an operation to be included in the dialog cluster candidate, the dummy dialog flag f_{d} is set to true.

That is, in the operation 5 in the state ST103 in FIG. 10, since the confirmation dialog flag fₐ of the operation Mₙ of the forward-matched cluster is not true in step S168 in the flowchart in FIG. 16, the process proceeds to step S173, and the dummy dialog flag f_{d} is set to true.

As a result, in the determination in step S66 in the flowchart of FIG. 9, the dummy dialog flag f_{d} is determined to be true, the process proceeds to step S59, and the operation 5 in the state ST103 of FIG. 10 is added as a dialog cluster candidate.

Furthermore, for example, since the operation 6 in the state ST133 in FIG. 14 is immediately after the operation 5 having a different Entity, the number of transitions Fₙ and the transition probability Pₙ of the operation 6 are low, and thus the habituation score Sₙ is lower than the threshold Sₜₕ, but since it is an operation to be included in the dialog cluster candidate, the dummy dialog flag f_{d} is set to true.

That is, in the operation 6 in the state ST133 in FIG. 14, since the confirmation dialog flag fₐ of the operation Mₙ of the forward-matched cluster is not true in step S168 in the flowchart in FIG. 16, the process proceeds to step S173, and the dummy dialog flag f_{d} is set to true.

As a result, in the determination in step S66 in the flowchart of FIG. 9, the dummy dialog flag f_{d} is determined to be true, the process proceeds to step S59, and the operation 6 in the state ST133 of FIG. 14 is added as a dialog cluster candidate.

Moreover, for example, since the operation 7 in the state ST142 in FIG. 15 is immediately after the operation 6 that has been deleted, the number of transitions Fₙ and the transition probability Pₙ of the operation 7 are low, and thus the habituation score Sₙ is lower than the threshold Sₜₕ, but since it is an operation to be included in the dialog cluster candidate, the dummy dialog flag f_{d} is set to true.

That is, in the operation 7 in the ST142 of FIG. 15, since the operation Mₙ and the operation n of the forward-matching cluster are not the same in step S167 in the flowchart of FIG. 16, the process proceeds to step S170.

Furthermore, then, when the operations from the operation Mₙ to the operation n of the forward-matching cluster are stored in the deleted operation array A_{d} by the processing in step S170, the number of stored operations is three or more in step S171, and thus the process proceeds to step S172.

Then, when the confirmation dialog flag fₐ is set to true in step S172, the dummy dialog flag f_{d} is set to true by the processing in step S173.

As a result, in the determination in step S66 in the flowchart of FIG. 9, the dummy dialog flag f_{d} is determined to be true, the process proceeds to step S59, and the operation 7 in the state ST142 is added as a dialog cluster candidate.

<Dialog Generation Case for Added and Deleted Operations>

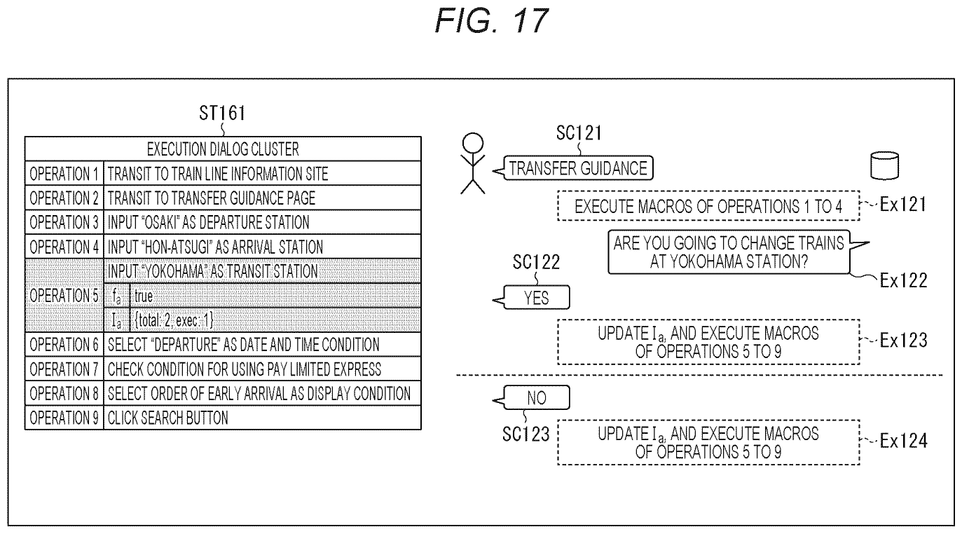

Next, a dialog generation case for an added operation and a deleted operation will be described with reference to FIG. 17.

For example, consider a case where a dialog cluster as illustrated in a state ST161 as illustrated in FIG. 17 is set.

Note that the dialog cluster in the state ST161 is the same as the dialog cluster in the state ST133 in FIG. 17.

In the operation 5 in the state ST161 in FIG. 17, since the confirmation dialog flag fₐ is set to true, a state is set in which execution by a dialog cluster is performed.

Here, for example, as illustrated in the right part of FIG. 17, when the user 11 utters “Transfer guidance” or the like in the processing SC121, the operation storage execution control unit 53 recognizes that an instruction to perform the dialog cluster illustrated in the left part of FIG. 17 related to the transfer guidance has been made.

In processing Ex121, the operation storage execution control unit 53 performs the macro of the operations 1 to 4 indicated in the left part of FIG. 17 in response to the utterance “Transfer guidance”.

In the processing Ex122, since the confirmation dialog flag fₐ is set to true in the processing of the operation 5, the operation storage execution control unit 53 outputs a speech prompting confirmation such as “Are you going to change trains at Yokohama station?”.

Here, in the processing SC122, when the user utters “Yes” or the like, the operation storage execution control unit 53 recognizes that an instruction to execute an operation of “inputting Yokohama to a transit station” has been given.

Therefore, in the processing Ex123, the operation storage execution control unit 53 increments the number of executions exec and the total number of times by 1 to update the number of executions exec and the total number of times so as to reflect the execution information indicating that the processing of “inputting Yokohama to a transit station” has been performed in the confirmation information Iₐ, and performs the operations 5 to 8.

Furthermore, instead of the processing SC122, as indicated by the processing SC123, when the user utters “No” or the like, the operation storage execution control unit 53 recognizes that an instruction not to execute an operation of “inputting Yokohama to a transit station” has been given.

In the processing Ex124, the operation storage execution control unit 53 increments only the total number of times by 1 to update the number of executions exec and the total number of times so as to reflect the execution information indicating that the processing of “inputting Yokohama to a transit station” has not been performed in the confirmation information Iₐ, and performs the operations 6 to 8.

By such a series of processing, when an operation of adding is performed, an inquiry dialog as to whether or not execution of the added operation is necessary, and processing according to the confirmation result is performed.

As a result, even if a change occurs in the habituation operation, a dialog cluster is set for the habituation operation cluster, and a flexible response is possible.

In FIG. 17, a case of utterance generation in the case of an added operation has been described, but this is similar for the case of a deleted operation, and thus the description thereof will be omitted.

<Dialog Processing for Added and Deleted Operations>

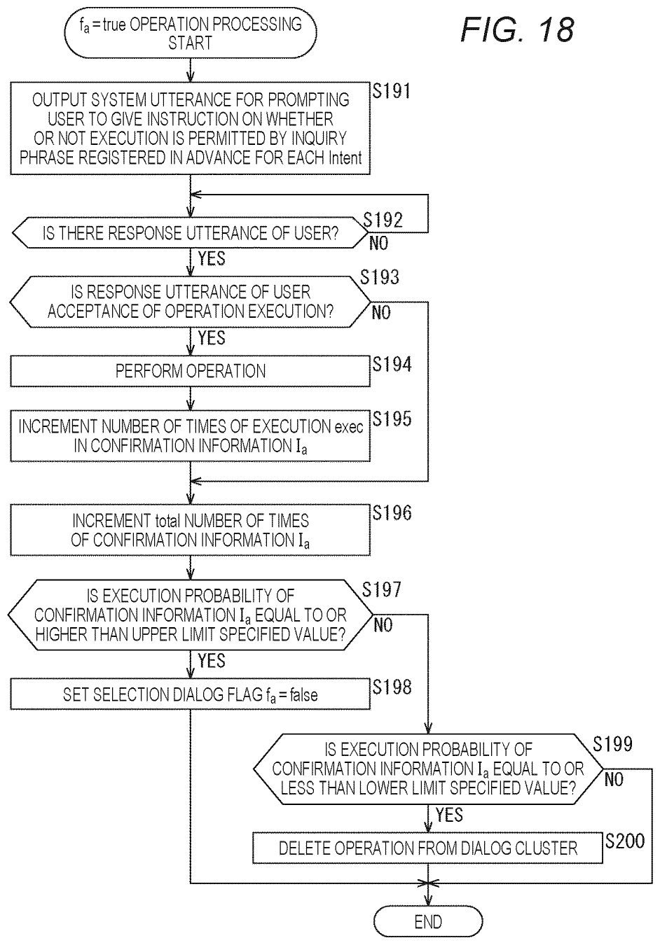

Next, interactive processing for added and deleted operations will be described with reference to the flowchart of FIG. 18.

Note that this processing is performed when the operation n in which the confirmation dialog flag fₐ is set to true is performed. That is, for example, the processing is performed when the processing of the operation 5 in the state ST161 of FIG. 17 is performed.

In step S191, the operation storage execution control unit 53 outputs a system utterance prompting the user to give an instruction on (respond) whether or not execution is permitted on the basis of an inquiry phrase registered in advance for each Intent.

In step S192, the operation storage execution control unit 53 determines whether or not there has been a response utterance of giving the instruction on whether or not execution is permitted from the user, and repeats similar processing until it is determined that there has been a response utterance.

Then, in a case where it is regarded in step S192 that there is a response utterance of giving the instruction on whether or not execution is permitted from the user, the process proceeds to step S193.

In step S193, the operation storage execution control unit 53 determines whether or not the response utterance giving the instruction on whether or not execution is permitted from the user is acceptance of execution.

Then, in a case where it is determined in step S193 that the response utterance giving the instruction on whether or not execution is permitted from the user is acceptance of execution, the process proceeds to step S194.

In step S194, the operation storage execution control unit 53 performs the operation n.

In step S195, the operation storage execution control unit 53 increments the number of executions exec in the confirmation information Iₐ by 1.

In step S196, the operation storage execution control unit 53 increments the total number of times in the confirmation information Iₐ by 1.

Note that, in step S193, in a case where the response utterance giving the instruction on whether or not execution is permitted from the user is not acceptance of execution, the processing S194 and the processing S195 are skipped.

In step S197, the operation storage execution control unit 53 calculates the execution probability in the confirmation information Iₐ, and determines whether or not the calculated execution probability is equal to or higher than the upper limit specified value.

In step S197, in a case where the execution probability in the confirmation information Iₐ is equal to or higher than the upper limit specified value, the process proceeds to step S198.

In step S198, the operation storage execution control unit 53 regards the operation n as an operation incorporated into a normal habituation operation cluster as a result of an increase in the execution probability as an added operation, sets the confirmation dialog flag fₐ of the operation n to false, and ends the process.

Furthermore, in step S197, in a case where the execution probability in the confirmation information Iₐ is not equal to or higher than the upper limit specified value, the process proceeds to step S199.

In step S199, the operation storage execution control unit 53 calculates the execution probability in the confirmation information Iₐ, and determines whether or not the calculated execution probability is equal to or lower than the lower limit specified value.

In step S199, in a case where the execution probability in the confirmation information Iₐ is equal to or lower than the lower limit specified value, the process proceeds to step S200.

In step S200, the operation storage execution control unit 53 regards that the operation n is in a state in which the deleted operation is not actually used continuously, the execution probability has decreased, and the operation n may be deleted, and deletes the operation n from the dialog cluster, and the process ends.

Note that, in step S199, in a case where the execution probability in the confirmation information Iₐ is not equal to or lower than the lower limit specified value, the processing of step S200 is skipped, and the process ends.

Through the above series of processing, for the operation in which the confirmation dialog flag fₐ is set to true, a response as to whether or not execution is permitted in the confirmation information Iₐ is prompted, and processing according to the response related to whether or not execution is permitted is performed.

Then, in a case where the instruction for the execution is given, the execution count exec is incremented by 1, and the total number of times is incremented by 1.

Moreover, in a case where the execution probability is sequentially calculated and becomes equal to or higher than the upper limit specified value, it is assumed that the user always performs the operation n, and the confirmation dialog flag fₐ is set to false and the operation is set to a fixed operation that is always performed.

Furthermore, in a case where the execution probability is sequentially calculated and becomes equal to or lower than the lower limit specified value, it is assumed that the user does not always perform the operation n, and the dialog cluster of the operation n itself is deleted and the operation is set to a state of not always being performed.

That is, in any case, when an added operation becomes a fixed operation or a deleted operation is deleted, the cluster functions as a normal habituation operation cluster in which no dialog is performed thereafter.

As a result, even if a change such as addition or deletion of an operation occurs in the habituation operation, a dialog cluster is set for the habituation operation cluster, and a flexible response is possible.

Through the above processing, it is possible to easily change the habituation operation cluster in which a plurality of operations is collectively operated as described below.

For example, it is assumed that there is a macro including a habituation operation cluster including an operation of turning off the air conditioner by an utterance phrase of “Good night” by combining a plurality of habitual operations at bedtime.

In a case where such a macro exists, in a hot season, when the user utters “Good night without turning off the air conditioner”, the confirmation dialog flag f a is set to true as the operation deleted from the habituation operation cluster in the “operation to turn off the air conditioner”, and recording is made as a dialog cluster.

Then, in the next and subsequent times, when the user utters “Good night”, an inquiry such as “Turn off the air conditioner?” is uttered on the basis of the confirmation dialog flag, and an execution rejection response such as “Do not turn off the air conditioner” continues as the response of the user, the execution probability of the “operation to turn off the air conditioner” in the confirmation information Iₐ decreases.

When the execution rejection response further continues and the execution probability in the confirmation information Iₐ of the operation to turn off the air conditioner becomes equal to or lower than the lower limit specified value, the “operation to turn off the air conditioner” is deleted from the macro constituted by the habituation operation cluster, and thereafter, the macro is performed without turning off the air conditioner without an inquiry about the air conditioner by the “Good night” utterance of the user.

That is, according to the above-described operation, utterance such as turning on the air conditioner and sleeping is made as the habituation operation of the user as the change in the season (getting hot), and thereby, the habituation operation cluster can be changed such that the macro is performed without performing the “operation to turn off the air conditioner”.

<Operation Depending on Observation Context>

Next, an operation depending on the observation context will be described with reference to FIG. 19.

A case where, for example, a habituation operation cluster including operations 1 to 8 illustrated in a state ST181 illustrated in the left part of FIG. 19 is generated and performed by the above-described habituation operation clustering processing will be considered.

Note that the state ST181 is the same as the state ST101 in FIG. 10.

Here, it is assumed that the attribute of location is set as a dependent context type Dc for the departure station input of the operation 3 among the operations 1 to 8 indicated by the state ST181 in the left part of FIG. 19.

The dependent context type Dc is information that designates a type of context information used when a habitual operation is performed.

As described above, in a case where the attribute of the location is set as the dependent context type DC, for example, when the location information detected (observed) by the GPS sensor or the like is acquired as observation context information Co and matches by comparison with the Entity of the operation 3, the context dialog flag f_{c} is set as indicated by the state ST182.

The context dialog flag f_{c} is, for example, a flag that sets whether or not to implement processing of presenting options of operations to the user through a dialog and allowing the user to select an operation in a case where an operation in which the Entity of the operation in which the dependent context type D_{c} is set and the observation context information Cₒ are different among the operations collectively operated set by the habituation operation cluster is performed.

For example, in a case where the vicinity of “Osaki”, which is the Entity of the operation of “inputting “Osaki” as the departure station” in the operation 3, is detected as the location information in the observation context information Cₒ, the context dialog flag f_{c} is set to true in the operation 3 as indicated by the state ST182 in FIG. 19.

Furthermore, when the context dialog flag f_{c} is set to true, the context information I_{c} is set in a state of an initial value.

Here, in the context information I_{c}, “Location” as the dependent context type D_{c} set in advance as an initial value is set, the total number of times of detection total is set to 2 (total: 2), 1 is set as the number of times of input (Cₒ: 1) of the observation context information Cₒ, and Osaki is set to 1 (entity: {Osaki: 1}) as the number of times of input of the Entity.

Thereafter, when the user inputs the departure station, the total number of times total of the context information Ic, the input Entity, or the observation context information Cₒ is incremented by 1, and the input probability (the number of times of input/the total number of times) of the options is calculated. Note that, in the initial value, the total number of times total is set to 2 so that the input probability of the number of times of input of the observation context information Co and the input probability of the number of times of input of the Entity are the same.

Accordingly, in the state ST182, the input probability of the observation context information Co and the input probability of Osaki are 0.5.

<Observation Context-Dependent Operation Determination Processing>

Next, observation context-dependent operation determination processing will be described with reference to a flowchart of FIG. 20. Note that the observation context-dependent operation determination processing in the flowchart of FIG. 20 is the processing of step S56 in the flowchart of FIG. 9.

In step S221, the operation storage execution control unit 53 determines whether or not the dependent context type D_{c} is set in the Intent attribute of the operation n.

In a case where it is determined in step S221 that the dependent context type D_{c} is set to the Intent attribute of the operation n, the process proceeds to step S222.

In step S222, the operation storage execution control unit 53 determines whether or not the observation context information Cₒ corresponding to the dependent context type D_{c} matches the Entity of the operation n.

In step S222, in a case where it is determined that the observation context information Co corresponding to the dependent context type D_{c} matches the Entity of the operation n, the process proceeds to step S223.

In step S223, the operation storage execution control unit 53 sets the initial value of the context information I_{c} for the operation n.

In step S224, the operation storage execution control unit 53 sets the context dialog flag f_{c} and sets the context dialog flag f_{c} to true for the operation n.

By the above processing, when the observation context information Co of the preset dependent context type D_{c} matches with the entity of the operation n, the number of times of input Co and the number of times of input of the Entity of the observation context information are each set to 1 as the initial value of the context information I_{c} for the operation n, the total number of times is set to 2, and the context dialog flag f_{c} is set to true.

<Context Information Update Processing of Dialog Cluster Candidate>

Next, the context information update processing of the dialog cluster candidate will be described with reference to the flowchart of FIG. 21. Note that the context information update processing of the dialog cluster candidate in the flowchart of FIG. 21 is processing of step S72 in the flowchart of FIG. 9.

In step S251, the operation storage execution control unit 53 sets an unprocessed operation among the stored cluster Z operations in the same sequence as the sequence of the dialog cluster candidate as the operation m to be processed.

In step S252, the operation storage execution control unit 53 determines whether or not the context dialog flag f_{c} of the operation m in the dialog cluster candidate is true and the context dialog flag f_{c} of the operation m in the stored cluster Z is true.

In a case where it is regarded in step S252 that the context dialog flag f_{c} of the operation m in the dialog cluster candidate is true and the context dialog flag f_{c} of the operation m in the stored cluster Z is true, the process proceeds to step S253.

In step S253, the operation storage execution control unit 53 determines whether or not the Entity E_{c} of the context information I_{c} in the operation m in the dialog cluster candidate matches the entity Eₘₐₓ in which the input probability of the context information I_{c} of the operation m in the stored cluster Z becomes the highest value.

In step S253, in a case where it is determined that the Entity E_{c} of the context information I_{c} in the operation m in the dialog cluster candidate does not match the entity Eₘₐₓ in which the input probability of the context information I_{c} of the operation m in the stored cluster Z becomes the highest value, the process proceeds to step S254.

In step S254, the operation storage execution control unit 53 increments the number of times of input of the observation context information Co of the context information I_{c} of the operation m of the cluster Z by 1.

In step S255, the operation storage execution control unit 53 increments the total number of times total of the context information I_{c} of the operation m of the cluster Z by 1.

In step S256, the operation storage execution control unit 53 sets the context information I_{c} of the operation m of the stored cluster Z as the context information I_{c} of the operation m of the dialog cluster candidate.

That is, in a case where the Entity E_{c} of the context information I_{c} in the operation m in the dialog cluster candidate does not match the entity Eₘₐₓ in which the input probability of the context information I_{c} of the operation m in the stored cluster Z becomes the highest value, the context information I_{c} of the stored cluster Z is updated.

Furthermore, in step S253, in a case where it is determined that the Entity E_{c} of the context information I_{c} in the operation m in the dialog cluster candidate matches the entity Eₘₐₓ in which the input probability of the context information I_{c} of the operation m in the stored cluster Z becomes the highest value, the processing of S254 and the processing of S255 are skipped, and the process proceeds to step S256.

That is, in a case where the Entity E_{c} of the context information I_{c} in the operation m in the dialog cluster candidate matches the entity Eₘₐₓ in which the input probability of the context information I_{c} of the operation m in the stored cluster becomes the highest value, the context information I_{c} of the operation m of the dialog cluster candidate is set to the same information as the context information I_{c} of the stored cluster Z.

In step S257, the operation storage execution control unit 53 determines whether or not there is an unprocessed operation among the stored cluster Z operations in the same sequence as the sequence of the dialog cluster candidate.

In step S257, in a case where it is determined that there is an unprocessed operation among the stored cluster Z operations in the same sequence as the sequence of the dialog cluster candidate, the process returns to step S251.

That is, the processing of steps S251 to S257 is repeated until the processing is performed for all the operations of the stored cluster Z in the same sequence as the sequence of the dialog cluster candidate.

Then, in a case where it is determined in step S257 that there is no unprocessed operation among the operations of the stored cluster Z in the same sequence as the sequence of the dialog cluster candidate, in a case where it is regarded that the processing has been performed for all the operations of the stored cluster Z in the same sequence as the sequence of the dialog cluster candidate, the process proceeds to step S258.

In step S258, the operation storage execution control unit 53 deletes the stored cluster Z having the same sequence as the sequence of the dialog cluster candidate, and the process ends.

By the above processing, in a case where there is a stored cluster Z having the same sequence as the sequence of the dialog cluster candidate, the context information I_{c} of the dialog cluster candidate is updated by the context information I_{c} of the stored cluster Z.

<Dialog Generation Case for Observation Context-Dependent Operation>

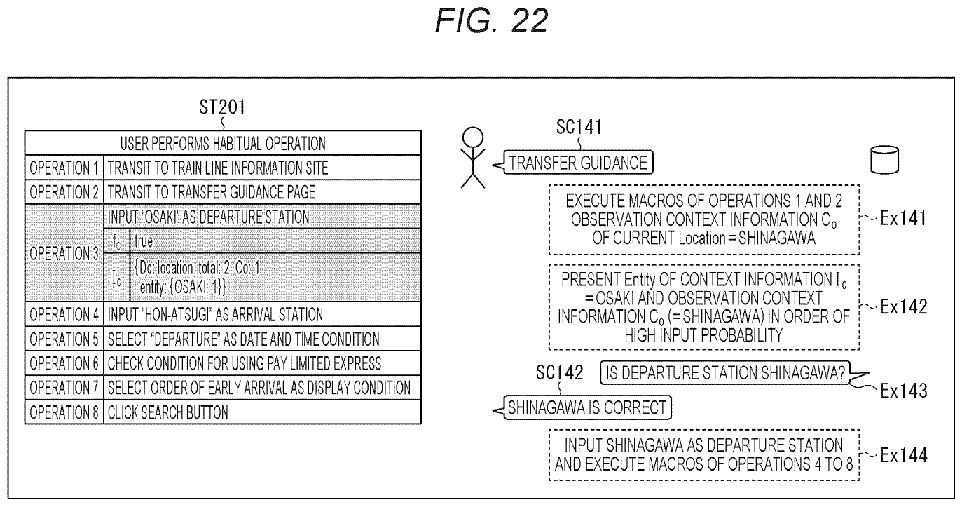

Next, a dialog generation case for an observation context-dependent operation will be described with reference to FIG. 22.

For example, consider a case where a dialog cluster as illustrated in a state ST201 as illustrated in FIG. 22 is set. Note that the dialog cluster in the state ST201 is the same as the dialog cluster in the state ST182 in FIG. 19.

In the operation 3 in the left part in FIG. 22, since the context dialog flag f_{c} is set to true, a state is set in which execution by a dialog cluster is performed.

Here, for example, as illustrated in the right part of FIG. 22, when the user 11 utters “Transfer guidance” or the like in the processing SC141, the operation storage execution control unit 53 recognizes that an instruction to perform the dialog cluster illustrated in the left part of FIG. 22 related to the transfer guidance has been made.

In processing Ex141, the operation storage execution control unit 53 performs the macro of the operations 1 and 2 indicated in the left part of FIG. 22 in response to the utterance “Transfer guidance”. Furthermore, here, it is assumed that “Shinagawa” is detected as the observation context information Co.

In processing Ex142, the operation storage execution control unit 53 performs the processing of the operation 3 and since the context dialog flag f_{c} is set to true, the processing is performed on the basis of the context information I_{c}.

More specifically, here, “Shinagawa” is detected as the observation context information Co and does not match “Osaki” that is the Entity in the context information IC, and thus the operation storage execution control unit 53 presents the options in the Entity in descending order of input probability. Note that, in a case where the input probabilities are the same, for example, the options may be presented from the most recently input options.

Then, in processing Ex143, the operation storage execution control unit 53 outputs a speech prompting the selection from the presented options such as “Is the departure station Shinagawa?”.

Here, in processing SC142, when the user utters “Shinagawa is correct” or the like, the operation storage execution control unit 53 recognizes that “Shinagawa” has been selected as an option.

Then, in processing Ex144, the operation storage execution control unit 53 inputs Shinagawa to the departure station to update the context information IC, and performs the operations 4 to 8.

That is, in a case where the context dialog flag f_{c} is true, when the Entity Eₘₐₓ (Osaki) having the highest input probability among the Entities in the context information I_{c} does not match the current observation context information Co (Shinagawa), an Entity to be an option is presented, the utterance of the inquiry is output, and the macro is executed with the selected Entity.

Furthermore, in a case where the entity Eₘₐₓ (Osaki) having the highest input probability among the Entities in the context information I_{c} matches the current observation context information Cₒ (Osaki), the macro is executed by the Entity Eₘₐₓ (Osaki) without making an inquiry to the user.

Moreover, in a case where an utterance input other than the presented options is made, the utterance input is added to the context information I_{c} to update the context information I_{c}.

When the input probability of the observation context information Cₒ in the context information I_{c} becomes equal to or higher than a specified value (for example, 0.8), the context dialog flag f_{c} is set to false, and thereafter, a macro in which the observation context information Cₒ is fixed as an Entity is executed.

Furthermore, when the input probability of a specific Entity in the context information I_{c} becomes equal to or higher than a specified value (for example, 0.8), the context dialog flag f_{c} is set to false, and thereafter, a macro in which an Entity having an input probability of equal to or higher than a specified value is fixed is executed.

By such a series of processing, when a change occurs in the habituation operation and the observation context information Co is different from the registered Entity Eₘₐₓ having the highest input probability, the Entity is presented as an option, and an inquiry dialog to prompt selection of any one is performed, and processing according to the selection result is performed.

As a result, even if a change occurs in the context associated with the habituation operation, a dialog cluster is set for the habituation operation cluster, and a flexible response is possible.

<Dialog Processing for Observation Context-Dependent Operation>

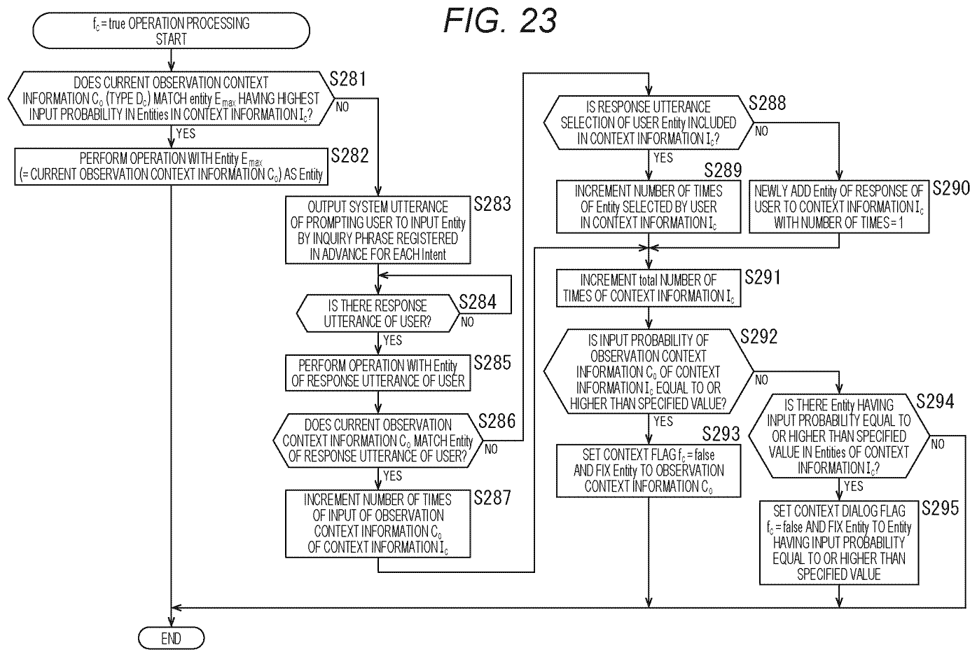

Next, dialog processing for an observation context-dependent operation will be described with reference to a flowchart of FIG. 23.

Note that this processing is performed when the operation in which the context dialog flag f_{c} is set to true is performed. That is, for example, the processing is performed when the processing of the operation 3 in the state ST201 of FIG. 22 is performed.

In step S281, the operation storage execution control unit 53 determines whether or not the observation context information Cₒ of the current preset dependent context type D_{c} matches the Entity Eₘₐₓ having the highest input probability among the Entities in the context information I_{c}.

In step S281, in a case where it is determined that the observation context information Cₒ of the current preset dependent context type Dc matches the Entity Eₘₐₓ having the highest input probability among the Entities in the context information I_{c}, the process proceeds to step S282.

In step S282, the operation storage execution control unit 53 performs the operation n using the observation context information Cₒ of the current preset dependent context type Dc as an Entity.

On the other hand, in step S281, in a case where it is determined that the observation context information Cₒ of the current preset dependent context type D_{c} does not match the Entity Eₘₐₓ having the highest input probability among the Entities in the context information I_{c}, the process proceeds to step S283.

In step S283, the operation storage execution control unit 53 outputs a system utterance prompting the user to select (respond) an option on the basis of an inquiry phrase registered in advance for each Intent.

In step S284, the operation storage execution control unit 53 determines whether or not there has been a response utterance that is a selection result of the user for the options, and repeats similar processing until it is determined that there has been a response utterance.

Then, in a case where it is regarded in step S284 that there is a response utterance that is a selection result of the user for the options, the process proceeds to step S285.

In step S285, the operation storage execution control unit 53 performs the operation n with the Entity of the option corresponding to the response utterance.

In step S286, the operation storage execution control unit 53 determines whether or not the observation context information Cₒ is the Entity of the response utterance of the user.

In step S286, in a case where it is determined that the observation context information Cₒ is the Entity of the response utterance of the user, the process proceeds to step S287.

In step S287, the operation storage execution control unit 53 increments the number of times of input of the observation context information Cₒ included in the context information I_{c} by 1, and the process proceeds to step S291.

On the other hand, in step S286, in a case where it is determined that the observation context information Cₒ is not the Entity of the response utterance of the user, the process proceeds to step S288.

In step S288, the operation storage execution control unit 53 determines whether or not the Entity selected by the response utterance is an Entity included in the context information I_{c}.

In step S288, in a case where it is determined that the Entity selected by the response utterance is the Entity included in the context information I_{c}, the process proceeds to step S289.

In step S289, the operation storage execution control unit 53 increments the information of the number of times of input of the Entity selected by the user in the context information I_{c} by 1.

On the other hand, in step S288, in a case where it is determined that the Entity selected by the response utterance is not the Entity included in the context information I_{c}, the process proceeds to step S290.

In step S290, the operation storage execution control unit 53 newly adds and sets the number of times of input of the Entity selected by the user in the context information I_{c} as an initial value 1.

In step S291, the operation storage execution control unit 53 increments the information of the total number of times total in the context information I_{c} by 1.

In step S292, the operation storage execution control unit 53 determines whether or not the input probability of the observation context information Cₒ in the context information I_{c} is equal to or higher than a specified value.

In step S292, in a case where it is determined that the input probability of the observation context information Cₒ in the context information I_{c} is equal to or higher than a specified value, the process proceeds to step S293.

In step S293, the operation storage execution control unit 53 sets the context dialog flag f_{c} to false and sets the operation in which the Entity is fixed to the observation context information Cₒ, and the process ends.

In step S292, in a case where it is determined that the input probability of the observation context information Co in the context information I_{c} is not equal to or higher than a specified value, the process proceeds to step S294.

In step S294, the operation storage execution control unit 53 determines whether or not there is an Entity having an input probability of equal to or higher than a specified value among Entities in the context information I_{c}.

In step S294, in a case where it is determined that there is an Entity whose input probability is equal to or higher than the specified value among the Entities in the context information I_{c}, the process proceeds to step S295.

In step S295, the operation storage execution control unit 53 sets the context dialog flag f_{c} to false and sets an operation in which the Entity is fixed to an Entity having the input probability of equal to or higher than a specified value, and the process ends.

In step S295, in a case where there is no Entity whose input probability is equal to or higher than the specified value among the Entities in the context information I_{c}, the processing of step S295 is skipped and the process ends.

Through the above-described series of processing, for the operation in which the context dialog flag f_{c} is set to true, when the observation context information Cₒ is the Entity Eₘₐₓ that is the highest value of the Entity in the context information I_{c}, the operation is performed with the Entity Eₘₐₓ as the Entity.

Furthermore, when the observation context information Cₒ is not the Entity Eₘₐₓ that becomes the highest value of the Entity in the context information I_{c}, an Entity that becomes an option is presented in the order of input probabilities and selection is prompted, and processing is performed with the selected Entity.

Then, for the selected Entity, the number of times is incremented by 1, and the total number of times is incremented by 1. At this time, in a case where a new Entity other than the Entity presented as an option is selected, the Entity is newly registered as an option and the number of times is set to 1.

Moreover, in a case where the input probabilities of the observation context information Cₒ and the Entity are sequentially calculated and become equal to or higher than the specified value, it is assumed that the user always selects an option of equal to or higher than the specified value as the observation context information Cₒ or the Entity, the context dialog flag f_{c} is set to false, and the operation is set to an operation fixed to the observation context information Cₒ or the Entity equal having the input probability of being always selected of equal to or higher than the specified value.

That is, in a case where an operation in which the observation context information Cₒ or the Entity is the fixed is set as described above, thereafter, a normal habituation operation cluster in which no dialog is performed functions.

As a result, even if a change occurs in the habituation operation, a dialog cluster is set for the habituation operation cluster, and a flexible response is possible.

### Application Example 1

In the above description, an example of a case where the dependent context type D_{c} is location (location information) has been described. However, other types may be used. For example, the dependent context type D_{c} may be set to dialog.

For example, in a case where the dependent context type D_{c} is set to dialog, the arrival station input operation of the transfer guidance may be performed on the basis of the immediately preceding dialog.

That is, in this case, the conversation content or the communication content such as chat, message, or SNS performed within a specified time from the timing at which the habituation operation cluster is performed is used as the context information obtained from the immediately preceding dialog, and the arrival station input operation of the transfer guidance is performed.

More specifically, in a case where the dependent context type D_{c} is set to dialog, when arrival station input=Yokohama is included as a topic in the immediately preceding chat, the context dialog flag f_{c} is set to true, and Yokohama is stored in the Entity of the context information I_{c}.

That is, in this case, the dependent context type Dc of the location of the arrival station is not the location (location information) but the previous dialog.

Accordingly, for example, when a macro including the habituation operation cluster is performed, if the observation context information Co obtained on the basis of the content of the immediately preceding chat includes “Ikebukuro” instead of “Yokohama” registered as the Entity of the context information I_{c}, an utterance to inquire whether the arrival station is Ikebukuro which is the observation context information Cₒ is made, an arrival station input operation according to the response of the user is performed, and the macro is executed.

### Application Example 2

The dependent context type Dc may be context information of vital information.

That is, the dependent context type D_{c} may be set to, for example, context information of vital information such as pulse indicating a pulse value, and when there is a macro including a music playlist selection operation, the pulse range may be set as meta-information.

With such setting, for example, a calm music is set in the play list corresponding to the meta-information of the low pulse range, and a music for running is set in the play list corresponding to the meta-information of the high pulse range.

Then, when the pulse as the observation context information Co of the pulse range set as the meta-information in the selected playlist is observed (detected) at the time of the playlist selection operation, the context dialog flag f_{c} is set to true, and the pulse range of the selected playlist is stored in the meta-information of the Entity of the context information I_{c}.

When the macro including the music playlist selection operation is performed, whether or not to perform the playlist selection operation is inquired when the pulse value which is the observation context information Cₒ is out of the pulse range stored in the context information I_{c}.

A playlist having meta-information in which the pulse value that is the observation context information Cₒ at the time of cluster execution is the pulse range may be presented as an option, and an inquiry may be made.

Furthermore, the dependent context type D_{c} in the playlist selection operation may be set to, for example, emotion indicating emotion or the like.

Here, the context information in a case where the dependent context type D_{c} is set to emotion is, for example, an emotion recognition result based on an image recognition result, a pulse value, a blood pressure value, or the like of the user, and an inquiry by utterance that prompts a selection operation of a playlist according to the emotion recognition result may be made.

### Application Example 3

As the dependent context type D_{c}, attribute indicating an attribute of a surrounding person may be set.

More specifically, in a case where there is a macro for performing a viewing video content selection operation, the context information when the dependent context type D_{c} is set to attribute is set to the attribute of the person around the user who performs the viewing video content selection operation.

For example, in a case where an age group or the like can be set as the attribute of the person around the user, for example, a target age range such as children (up to 12 years old), 18 years old or older, or the like is set as the meta-information for the content to be an option in the viewing video content selection operation.

Therefore, when the macro including the viewing video content selecting operation is performed, if the observation context information Cₒ of the dependent context type D_{c} including the age of the person around the user recognized by the image is detected in the target age range set as the meta-information in the selected content, the context dialog flag f_{c} is set to true, and the target age range of the content selected in the meta-information is stored as the Entity of the context information I_{c}.

Then, when the macro including the viewing video content selection operation is performed, in a case where the observation context information Cₒ including the age of the person around the user recognized by the image is out of the target age range stored in the context information I_{c}, an utterance may be made as to whether or not the video may be reproduced although the person outside the target age is present around the user when the viewing video content selection operation is performed.

For example, when the macro including the viewing video content selection operation is performed, it may be inquired whether or not to select the video content for children, which is habitually watched together with children, even when there is no child.

### Other Application Examples

The dependent context type Do may be set to an online/offline state or the like via a network between users. For example, according to the online/offline which is the observation context information Cₒ, it may be regarded that the user in the online state can immediately receive and read the message, and it may be regarded that the user in the offline state cannot immediately read the message.

In this case, for example, according to the online/offline information which is the observation context information Cₒ, the inquiry dialog may not be performed in a case where the user who can immediately receive and read the message is designated as the destination of the message transmission, and the inquiry dialog as to whether the user who cannot immediately read the message may be included in the destination may be performed in a case where the user who cannot immediately read the message is designated as the destination of the message transmission.

Furthermore, the dependent context type D_{c} may be a relationship or the like with a person present at the place, and for example, on/off of input regarding privacy and operation of a presentation system may be set according to a relationship with a person present at the place as the observation context information Cₒ.

Moreover, the dependent context type D_{c} may be a time zone or the like when an inquiry such as “Tell me the weather” is made, and for example, according to a time zone which is the observation context information Cₒ, the weather of today may be presented in the morning, and the weather of tomorrow may be presented in the night.

(Modification 1)

The dialog flag may also be set for correction/addition of an operation before/after execution of the macro including the habituation operation cluster.

That is, for example, in a case of “the departure station is Shinagawa and the usual transfer guidance”, the selection dialog flag fₛ for presenting an option of the departure station may be set.

Furthermore, after the macro is executed by the utterance of “the usual transfer guidance”, the operation executed by the utterance of “redo with Yokohama as the transit station” may be regarded as the added operation, the confirmation dialog flag fₐ may be set, and whether or not execution of the added operation is permitted may be inquired.

(Modification 2)

In a case where a control function of a home appliance is used by cooperation via a device such as a smart speaker and a specific operation in a macro including a habituation operation cluster cannot be performed due to context dependence and an error occurs, the macro may be executed while suppressing the occurrence of the error by changing the dependent context type D_{c} as a factor of the error without inquiry utterance as long as the dependent context type D_{c} can be changed.

That is, for example, in a case where the macro including the air conditioner temperature setting operation is executed on the basis of the context information of the dependent context type D_{c} indicating the power supply state of the air conditioner, when the macro is executed while the power supply of the air conditioner is in the OFF state, the air conditioner may be turned on at the timing when the air conditioner temperature setting operation is performed so that the air conditioner temperature setting operation can be implemented.

(Modification 3)

Furthermore, it is also assumed that different types and a plurality of dialog flags are set for a specific operation by the dialog clustering processing described with reference to the flowchart of FIG. 9, and an inquiry is made by utterances a plurality of times when the specific operation is performed.

In such a case, it is also conceivable that the subsequent sequence causes functional inconsistency depending on the response content to the inquiry of the user.

This inconsistency is resolved by reflecting the habituation of the user response when the operation is performed several times, but the inquiry may not be made according to the presence or absence of the inconsistency of the subsequent sequence at the time of the response of the user.

That is, for example, in a case where there is a macro that implements transfer guidance by checking that the departure station is Osaki, Yokohama or Hon-Atsugi is selected as an arrival station by the selection dialog flag, and the transit station is Yokohama by the confirmation dialog flag, when Yokohama is selected as the arrival station by the user at the time of execution and then Yokohama is selected as the transit station, the arrival station and the transit station are the same, and thus inconsistency occurs.

Therefore, since it is inconsistent that the transit station is Yokohama at the same time when Yokohama is selected as the arrival station as described above, an inquiry as to whether or not the transit station is set to Yokohama may not be made.

As described above, in the present disclosure, operations having a high degree of habituation and do not need to be changed are collectively performed as one macro as a habituation operation cluster, and an operation that is desired to be changed depending on a situation or the like is performed on the basis of a response to an inquiry.

As a result, it is possible to change the habituation operation cluster forming the macro by an optimal dialog that is attentive to the user.

Furthermore, in a case where the response of the user to the inquiry about the specific operation is regarded as habituation of the same answer, the probability information (input probability or execution probability) in the dialog cluster is updated. When the value of the probability information becomes larger than a specified value, an operation fixed to the habituation answer is performed, and the inquiry is not performed. Therefore, the user can change a plurality of operations and collectively perform the operations without performing unnecessary dialog.

Moreover, since the inquiry is made only when necessary according to the situation (context) of the place where the user is located, the user can implement the change of the appropriate operation content with a low load even in a situation different from the situation where the user habitually performs the combined operation.

### 3. Example of Executing by Software

Incidentally, the series of processing described above can be also executed by hardware. However, the series of processing can also be executed by software. In a case of executing a series of processing by software, a program included in the software is installed from a recording medium to a computer incorporated in dedicated hardware, for example, a general-purpose computer that can execute various functions by installing various programs, or the like.

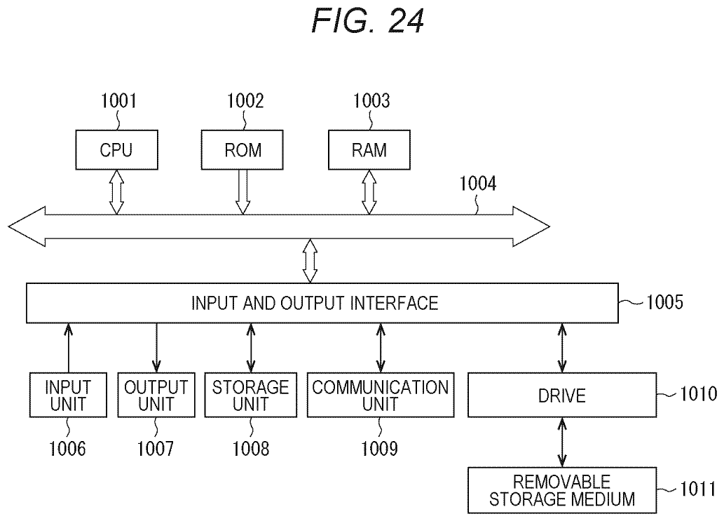

FIG. 24 illustrates a configuration example of a general-purpose computer. This personal computer has a built-in central processing unit (CPU) 1001. An input and output interface 1005 is connected to the CPU 1001 via a bus 1004. A read only memory (ROM) 1002 and a random access memory (RAM) 1003 are connected to the bus 1004.

The input and output interface 1005 is connected with an input unit 1006 including an input device such as a keyboard, or a mouse for inputting operation commands by the user, an output unit 1007 that outputs an image of a processing operation screen or a processing result to a display device, a storage unit 1008 including a hard disk drive or the like for storing programs and various data, and a communication unit 1009 including a local area network (LAN) adapter or the like and performing communication processing via a network typified by the Internet. Furthermore, the input and output interface 1005 is connected with a drive 1010 that reads and writes data with respect to a removable storage medium 1011 such as a magnetic disc (including a flexible disc), an optical disc (including compact disc-read only memory (CD-ROM) and a digital versatile disc (DVD)), a magneto-optical disc (including mini disc (MD)), or a semiconductor memory.

The CPU 1001 is read out from a program stored in the ROM 1002 or the removable storage medium 1011 such as a magnetic disc, an optical disc, a magneto-optical disc, or a semiconductor memory, is installed in the storage unit 1008, and executes various processing in accordance with a program loaded into the RAM 1003 from the storage unit 1008. Furthermore, the RAM 1003 appropriately stores also data or the like necessary for the CPU 1001 to execute various processing.

In the computer configured as described above, for example, the CPU 1001 loads the program stored in the storage unit 1008 into the RAM 1003 via the input and output interface 1005 and the bus 1004, and executes the program, so that the above-described series of processing is performed.

The program executed by the computer (CPU 1001) can be provided by being recorded on the removable storage medium 1011 as a package medium or the like, for example. Furthermore, the program can be provided via a wired or wireless transmission medium such as a local area network, the Internet, or digital satellite broadcasting.

In the computer, a program can be installed in the storage unit 1008 via the input and output interface 1005 by mounting the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program of processing in chronological order according to the order described in the present specification or may be a program of processing in parallel or at necessary timing such as when a call is made.

Note that the CPU 1001 in FIG. 24 implements the function of the operation storage execution control unit 53 in FIG. 4, and the storage unit 1008 and the removable storage medium 1011 implement the functions of the user operation history storage unit 54 and the habituation operation/dialog cluster storage unit 55.

Furthermore, in this specification, a system means a set of a plurality of constituent elements (devices, modules (parts), or the like), and it does not matter whether or not all constituent elements are in the same casing. Therefore, a plurality of devices that is housed in separate housings and is connected via a network, and one device in which a plurality of modules is housed in one housing are both systems.

Note that the embodiments of the present disclosure are not limited to the above-described embodiments, and various modifications are possible without departing from the gist of the present disclosure.

For example, in the present disclosure, it is possible to adopt a configuration of cloud computing in which one function is shared by a plurality of devices via a network, and is collaboratively processed.

Furthermore, each step described in the above-described flowchart can be executed by one device or shared by a plurality of devices.

Moreover, in a case where a plurality of pieces of processing is included in one step, a plurality of pieces of processing included in the one step can be executed by one device or shared and executed by a plurality of devices.

Note that, the present disclosure can adopt the following configuration.

<1> An information processing apparatus including
a control unit that calculates a habituation score indicating habituation of a user operation, and
registers a cluster including a plurality of operations including an operation in which the habituation score is higher than a predetermined threshold and an operation according to a dialog with a user.

<2> The information processing apparatus according to <1>,
in which the operation according to the dialog with the user is an operation having the same operation type and a different attribute, and
the control unit sets, with a selection dialog flag, whether or not to perform a dialog related to selection of the attribute in the operation having the same operation type and the different attribute.

<3> The information processing apparatus according to <2>,
in which, when the dialog related to the selection of the attribute is performed, the control unit sets the selection dialog flag to true and sets information on the attribute to be an option in the dialog as option information.

<4> The information processing apparatus according to <3>,
in which the control unit performs the dialog by presenting the attribute that is the option in the option information to the user, and performs an operation on the basis of the attribute corresponding to the option selected by the user.

<5> The information processing apparatus according to <4>,
in which the control unit sets the number of times selected by the user as a number of times of selection for each of the option in the option information, and sets a total number of times of all of the number of times of selection.

<6> The information processing apparatus according to <5>,
in which the control unit obtains an input probability of each of the option on the basis of the number of times of selection of each of the option in the option information and the total number of times, presents the attribute to the user in an order according to the input probability to perform the dialog, and performs an operation on the basis of the attribute corresponding to the option selected by the user.

<7> The information processing apparatus according to <6>,
in which, in a case where the input probability of any of the option is higher than a specified value, the control unit sets the selection dialog flag to false, and performs an operation in which the attribute that is an option having the input probability higher than the specified value is fixed.

<8> The information processing apparatus according to <1>,
in which the operation corresponding to the dialog with the user is an operation including an added operation and a deleted operation by a plurality of registered operations included in the cluster, and
the control unit sets whether or not to perform a dialog for confirming whether or not to perform the added operation or the deleted operation by a confirmation dialog flag.

<9> The information processing apparatus according to <8>,
in which, when a dialog for confirming whether or not to perform the added operation or the deleted operation is performed, the control unit sets the confirmation dialog flag to true, and sets, as confirmation information, a number of executions at which the added operation or the deleted operation has been performed by the confirmation by the dialog, and a total number of times the confirmation has been performed.

<10> The information processing apparatus according to <9>,
in which the control unit performs the dialog for confirming whether or not to perform the added operation or the deleted operation, and performs an operation according to a response of the user.

<11> The information processing apparatus according to <10>,
in which the control unit obtains an execution probability that the added operation or the deleted operation in the confirmation information is desired to be performed on the basis of the number of executions and the total number of times for the added operation or the deleted operation in the confirmation information.

<12> The information processing apparatus according to <11>,
in which, in a case where the execution probability of the added operation or the deleted operation is higher than a specified value, the control unit sets the confirmation dialog flag to false.

<13> The information processing apparatus according to <11>,
in which, in a case where the execution probability of the added operation or the deleted operation is lower than a specified value, the control unit deletes the cluster for which the confirmation dialog flag has been set.

<14> The information processing apparatus according to <1>,
in which the operation according to the dialog with the user is an observation context-dependent operation including an operation depending on an observation context, and
the control unit sets whether or not to perform a dialog related to selection of an option in the observation context-dependent operation by a context dialog flag.

<15> The information processing apparatus according to <14>,
in which, when the dialog related to the selection of the option including the observation context-dependent operation is performed, the control unit sets the context dialog flag to true, and sets information on an attribute depending on the observation context and information on the observation context that are the option in the dialog, as context information.

<16> The information processing apparatus according to <15>,
in which the control unit performs the dialog by presenting the attribute depending on the observation context and the observation context that are the option in the context information to the user, and performs an operation on the basis of the attribute corresponding to the option selected by the user.

<17> The information processing apparatus according to <16>,
in which the control unit sets the number of times selected by the user as a number of times of selection for each of the option in the context information, and sets a total number of times of all of the number of times of selection.

<18> The information processing apparatus according to <17>,
in which the control unit obtains an input probability of each of the option on the basis of the number of times of selection of each of the option in the context information and the total number of times, presents the attribute to the user in an order according to the input probability to perform the dialog, and performs an operation on the basis of the attribute corresponding to the option selected by the user.

<19> The information processing apparatus according to <18>,
in which, in a case where the input probability of any of the option is higher than a specified value, the control unit sets the context dialog flag to false, and performs an operation in which the attribute that is an option having the input probability higher than the specified value or the observation context is fixed.

<20> The information processing apparatus according to any one of <1> to <19>,
in which the habituation score is calculated on the basis of a harmonic function of a time interval from an immediately preceding operation to a current operation, the number of transitions from the immediately preceding operation to the current operation, and a transition probability from the immediately preceding operation to the current operation.

<21> An information processing method including
calculating a habituation score indicating habituation of a user operation, and
registering a cluster including a plurality of operations including an operation in which the habituation score is higher than a predetermined threshold and an operation according to a dialog with a user.

<22> A program that causes a computer to function as
a control unit that calculates a habituation score indicating habituation of a user operation, and
registers a cluster including a plurality of operations including an operation in which the habituation score is higher than a predetermined threshold and an operation according to a dialog with a user.

### REFERENCE SIGNS LIST

41 Information processing apparatus
51 Input operation unit
52 Functional application program execution unit
53 Operation storage execution control unit
54 User operation history storage unit
55 Habituation operation/dialog cluster storage unit
56 Speech input unit
57 Speech recognition processing unit
58 Utterance semantic understanding processing unit
59 Image input unit
60 Image recognition processing unit
61 Sensor input unit
62 Sensor recognition unit
63 Response generation unit
64 Display image processing unit
65 Speech synthesis processing unit
66 Image output unit
67 Speech output unit

1. An information processing apparatus comprising
a control unit that calculates a habituation score indicating habituation of a user operation, and
registers a cluster including a plurality of operations including an operation in which the habituation score is higher than a predetermined threshold and an operation according to a dialog with a user.

2. The information processing apparatus according to claim 1,
wherein the operation according to the dialog with the user is an operation having the same operation type and a different attribute, and
the control unit sets, with a selection dialog flag, whether or not to perform a dialog related to selection of the attribute in the operation having the same operation type and the different attribute.

3. The information processing apparatus according to claim 2,
wherein, when the dialog related to the selection of the attribute is performed, the control unit sets the selection dialog flag to true and sets information on the attribute to be an option in the dialog as option information.

4. The information processing apparatus according to claim 3,
wherein the control unit performs the dialog by presenting the attribute that is the option in the option information to the user, and performs an operation on a basis of the attribute corresponding to the option selected by the user.

5. The information processing apparatus according to claim 4,
wherein the control unit sets the number of times selected by the user as a number of times of selection for each of the option in the option information, and sets a total number of times of all of the number of times of selection.

6. The information processing apparatus according to claim 5,
wherein the control unit obtains an input probability of each of the option on a basis of the number of times of selection of each of the option in the option information and the total number of times, presents the attribute to the user in an order according to the input probability to perform the dialog, and performs an operation on a basis of the attribute corresponding to the option selected by the user.

7. The information processing apparatus according to claim 6,
wherein, in a case where the input probability of any of the option is higher than a specified value, the control unit sets the selection dialog flag to false, and performs an operation in which the attribute that is an option having the input probability higher than the specified value is fixed.

8. The information processing apparatus according to claim 1,
wherein the operation corresponding to the dialog with the user is an operation including an added operation and a deleted operation by a plurality of registered operations included in the cluster, and
the control unit sets whether or not to perform a dialog for confirming whether or not to perform the added operation or the deleted operation by a confirmation dialog flag.

9. The information processing apparatus according to claim 8,
wherein, when a dialog for confirming whether or not to perform the added operation or the deleted operation is performed, the control unit sets the confirmation dialog flag to true, and sets, as confirmation information, a number of executions at which the added operation or the deleted operation has been performed by the confirmation by the dialog, and a total number of times the confirmation has been performed.

10. The information processing apparatus according to claim 9,
wherein the control unit performs the dialog for confirming whether or not to perform the added operation or the deleted operation, and performs an operation according to a response of the user.

11. The information processing apparatus according to claim 10,
wherein the control unit obtains an execution probability that the added operation or the deleted operation in the confirmation information is desired to be performed on a basis of the number of executions and the total number of times for the added operation or the deleted operation in the confirmation information.

12. The information processing apparatus according to claim 11,
wherein, in a case where the execution probability of the added operation or the deleted operation is higher than a specified value, the control unit sets the confirmation dialog flag to false.

13. The information processing apparatus according to claim 11,
wherein, in a case where the execution probability of the added operation or the deleted operation is lower than a specified value, the control unit deletes the cluster for which the confirmation dialog flag has been set.

14. The information processing apparatus according to claim 1,
wherein the operation according to the dialog with the user is an observation context-dependent operation including an operation depending on an observation context, and
the control unit sets whether or not to perform a dialog related to selection of an option in the observation context-dependent operation by a context dialog flag.

15. The information processing apparatus according to claim 14,
wherein, when the dialog related to the selection of the option including the observation context-dependent operation is performed, the control unit sets the context dialog flag to true, and sets information on an attribute depending on the observation context and information on the observation context that are the option in the dialog, as context information.

16. The information processing apparatus according to claim 15,
wherein the control unit performs the dialog by presenting the attribute depending on the observation context and the observation context that are the option in the context information to the user, and performs an operation on a basis of the attribute corresponding to the option selected by the user.

17. The information processing apparatus according to claim 16,
wherein the control unit sets the number of times selected by the user as a number of times of selection for each of the option in the context information, and sets a total number of times of all of the number of times of selection.

18. The information processing apparatus according to claim 17,
wherein the control unit obtains an input probability of each of the option on a basis of the number of times of selection of each of the option in the context information and the total number of times, presents the attribute to the user in an order according to the input probability to perform the dialog, and performs an operation on a basis of the attribute corresponding to the option selected by the user.

19. The information processing apparatus according to claim 18,
wherein, in a case where the input probability of any of the option is higher than a specified value, the control unit sets the context dialog flag to false, and performs an operation in which the attribute that is an option having the input probability higher than the specified value or the observation context is fixed.

20. The information processing apparatus according to claim 1,
wherein the habituation score is calculated on a basis of a harmonic function of a time interval from an immediately preceding operation to a current operation, the number of transitions from the immediately preceding operation to the current operation, and a transition probability from the immediately preceding operation to the current operation.
